(19) United States
(12) Patent Application Publication
(10) Pub. No.: US 2018/0113431 A1
(43) Pub. Date: Apr. 26, 2018

(54) SYSTEMS AND METHODS PROVIDING FOR PREDICTIVE MOBILE MANUFACTURING

(71) Applicant: Wal-Mart Stores, Inc., Bentonville, AR (US)

(72) Inventors: Bruce W. Wilkinson, Rogers, AR (US); Todd D. Mattingly, Bentonville, AR (US)

(21) Appl. No.: 15/783,645

(22) Filed: Oct. 13, 2017

Related U.S. Application Data
(60) Provisional application No. 62/413,304, filed on Oct. 26, 2016.
(60) Provisional application No. 62/413,312, filed on Oct. 26, 2016.
(60) Provisional application No. 62/436,842, filed on Dec. 20, 2016.
(60) Provisional application No. 62/485,045, filed on Apr. 13, 2017.

(51) Int. Cl. G05B 19/19; G06N 5/02

(52) U.S. Cl. CPC G05B 19/19; G05B 2219/41091; G06N 5/025

(57) ABSTRACT

Systems, apparatuses, and methods are provided herein for predictive mobile manufacturing. A system for providing mobile manufacturing comprises a customer profile database storing customer partiality vectors associated with a plurality of customers, a product database storing vectorized product characterizations associated with a plurality of products, a mobile manufacturing unit comprising a vehicle carrying manufacturing equipment; and a control circuit. The control circuit being configured to select a plurality of customer profiles associated with a geographic area from the customer profile database, aggregate a plurality of customer partiality vectors to determine aggregated area customer partiality vectors, determine alignments between the aggregated area customer partiality vectors and vectorized product characterizations, select one or more products to manufacture with the mobile manufacturing unit, and instruct the mobile manufacturing unit to begin manufacturing the one or more products prior to receiving orders for the one or more products

### RELATED APPLICATION(S)

This application claims the benefit of U.S. Provisional application No. 62/413,312 filed Oct. 26, 2016, U.S. Provisional application No. 62/413,304 filed Oct. 26, 2016, U.S. Provisional application No. 62/436,842, filed Dec. 20, 2016, U.S. Provisional application No. 62/485,045, filed Apr. 13, 2017, which are all incorporated by reference in their entirety herein.

### TECHNICAL FIELD

These teachings relate generally to providing products and services to individuals.

### BACKGROUND

Various shopping paradigms are known in the art. One approach of long-standing use essentially comprises displaying a variety of different goods at a shared physical location and allowing consumers to view/experience those offerings as they wish to thereby make their purchasing selections. This model is being increasingly challenged due at least in part to the logistical and temporal inefficiencies that accompany this approach and also because this approach does not assure that a product best suited to a particular consumer will in fact be available for that consumer to purchase at the time of their visit.

Increasing efforts are being made to present a given consumer with one or more purchasing options that are selected based upon some preference of the consumer. When done properly, this approach can help to avoid presenting the consumer with things that they might not wish to consider. That said, existing preference-based approaches nevertheless leave much to be desired. Information regarding preferences, for example, may tend to be very product specific and accordingly may have little value apart from use with a very specific product or product category. As a result, while helpful, a preferences-based approach is inherently very limited in scope and offers only a very weak platform by which to assess a wide variety of product and service categories.

### BRIEF DESCRIPTION OF THE DRAWINGS

The above needs are at least partially met through provision of the vector-based characterizations of products described in the following detailed description, particularly when studied in conjunction with the drawings, wherein:

FIG. 1 comprises a flow diagram as configured in accordance with various embodiments of these teachings;

FIG. 2 comprises a flow diagram as configured in accordance with various embodiments of these teachings;

FIG. 3 comprises a graphic representation as configured in accordance with various embodiments of these teachings;

FIG. 4 comprises a graph as configured in accordance with various embodiments of these teachings;

FIG. 5 comprises a flow diagram as configured in accordance with various embodiments of these teachings;

FIG. 6 comprises a graphic representation as configured in accordance with various embodiments of these teachings;

FIG. 7 comprises a graphic representation as configured in accordance with various embodiments of these teachings;

FIG. 8 comprises a graphic representation as configured in accordance with various embodiments of these teachings;

FIG. 9 comprises a flow diagram as configured in accordance with various embodiments of these teachings;

FIG. 10 comprises a flow diagram as configured in accordance with various embodiments of these teachings;

FIG. 11 comprises a graphic representation as configured in accordance with various embodiments of these teachings;

FIG. 12 comprises a graphic representation as configured in accordance with various embodiments of these teachings;

FIG. 13 comprises a block diagram as configured in accordance with various embodiments of these teachings;

FIG. 14 comprises a flow diagram as configured in accordance with various embodiments of these teachings;

FIG. 15 comprises a graph as configured in accordance with various embodiments of these teachings;

FIG. 16 comprises a flow diagram as configured in accordance with various embodiments of these teachings;

FIG. 17 comprises a block diagram as configured in accordance with various embodiments of these teachings;

FIG. 18 comprises an illustration of a system as configured in accordance with various embodiments of these teachings;

FIG. 19 comprises a flow diagram as configured in accordance with various embodiments of these teachings;

FIG. 20 comprises a flow diagram as configured in accordance with various embodiments of these teachings; and

FIG. 21 comprises a block diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, many of these embodiments provide for a memory having information stored therein that includes partiality information for each of a plurality of persons in the form of a plurality of partiality vectors for each of the persons wherein each partiality vector has at least one of a magnitude and an angle that corresponds to a magnitude of the person's belief in an amount of good that comes from an order associated with that partiality. This memory can also contain vectorized characterizations for each of a plurality of products, wherein each of the vectorized characterizations includes a measure regarding an extent to which a corresponding one of the products accords with a corresponding one of the plurality of partiality vectors.

Rules can then be provided that use the aforementioned information in support of a wide variety of activities and results. Although the described vector-based approaches bear little resemblance (if any) (conceptually or in practice) to prior approaches to understanding and/or metricizing a given person's product/service requirements, these approaches yield numerous benefits including, at least in some cases, reduced memory requirements, an ability to accommodate (both initially and dynamically over time) an essentially endless number and variety of partialities and/or product attributes, and processing/comparison capabilities that greatly ease computational resource requirements and/or greatly reduced time-to-solution results.

So configured, these teachings can constitute, for example, a method for automatically correlating a particular product with a particular person by using a control circuit to obtain a set of rules that define the particular product from amongst a plurality of candidate products for the particular person as a function of vectorized representations of partialities for the particular person and vectorized characterizations for the candidate products. This control circuit can also obtain partiality information for the particular person in the form of a plurality of partiality vectors that each have at least one of a magnitude and an angle that corresponds to a magnitude of the particular person's belief in an amount of good that comes from an order associated with that partiality and vectorized characterizations for each of the candidate products, wherein each of the vectorized characterizations indicates a measure regarding an extent to which a corresponding one of the candidate products accords with a corresponding one of the plurality of partiality vectors. The control circuit can then generate an output comprising identification of the particular product by evaluating the partiality vectors and the vectorized characterizations against the set of rules.

The aforementioned set of rules can include, for example, comparing at least some of the partiality vectors for the particular person to each of the vectorized characterizations for each of the candidate products using vector dot product calculations. By another approach, in lieu of the foregoing or in combination therewith, the aforementioned set of rules can include using the partiality vectors and the vectorized characterizations to define a plurality of solutions that collectively form a multi-dimensional surface and selecting the particular product from the multi-dimensional surface. In such a case the set of rules can further include accessing other information (such as objective information) for the particular person comprising information other than partiality vectors and using the other information to constrain a selection area on the multi-dimensional surface from which the particular product can be selected.

People tend to be partial to ordering various aspects of their lives, which is to say, people are partial to having things well arranged per their own personal view of how things should be. As a result, anything that contributes to the proper ordering of things regarding which a person has partialities represents value to that person. Quite literally, improving order reduces entropy for the corresponding person (i.e., a reduction in the measure of disorder present in that particular aspect of that person's life) and that improvement in order/reduction in disorder is typically viewed with favor by the affected person.

Generally speaking a value proposition must be coherent (logically sound) and have “force.” Here, force takes the form of an imperative. When the parties to the imperative have a reputation of being trustworthy and the value proposition is perceived to yield a good outcome, then the imperative becomes anchored in the center of a belief that “this is something that I must do because the results will be good for me.” With the imperative so anchored, the corresponding material space can be viewed as conforming to the order specified in the proposition that will result in the good outcome.

Pursuant to these teachings a belief in the good that comes from imposing a certain order takes the form of a value proposition. It is a set of coherent logical propositions by a trusted source that, when taken together, coalesce to form an imperative that a person has a personal obligation to order their lives because it will return a good outcome which improves their quality of life. This imperative is a value force that exerts the physical force (effort) to impose the desired order. The inertial effects come from the strength of the belief. The strength of the belief comes from the force of the value argument (proposition). And the force of the value proposition is a function of the perceived good and trust in the source that convinced the person's belief system to order material space accordingly. A belief remains constant until acted upon by a new force of a trusted value argument. This is at least a significant reason why the routine in people's lives remains relatively constant.

Newton's three laws of motion have a very strong bearing on the present teachings. Stated summarily, Newton's first law holds that an object either remains at rest or continues to move at a constant velocity unless acted upon by a force, the second law holds that the vector sum of the forces F on an object equal the mass m of that object multiplied by the acceleration a of the object (i.e., F=ma), and the third law holds that when one body exerts a force on a second body, the second body simultaneously exerts a force equal in magnitude and opposite in direction on the first body.

Relevant to both the present teachings and Newton's first law, beliefs can be viewed as having inertia. In particular, once a person believes that a particular order is good, they tend to persist in maintaining that belief and resist moving away from that belief. The stronger that belief the more force an argument and/or fact will need to move that person away from that belief to a new belief.

Relevant to both the present teachings and Newton's second law, the “force” of a coherent argument can be viewed as equaling the “mass” which is the perceived Newtonian effort to impose the order that achieves the aforementioned belief in the good which an imposed order brings multiplied by the change in the belief of the good which comes from the imposition of that order. Consider that when a change in the value of a particular order is observed then there must have been a compelling value claim influencing that change. There is a proportionality in that the greater the change the stronger the value argument. If a person values a particular activity and is very diligent to do that activity even when facing great opposition, we say they are dedicated, passionate, and so forth. If they stop doing the activity, it begs the question, what made them stop? The answer to that question needs to carry enough force to account for the change.

And relevant to both the present teachings and Newton's third law, for every effort to impose good order there is an equal and opposite good reaction.

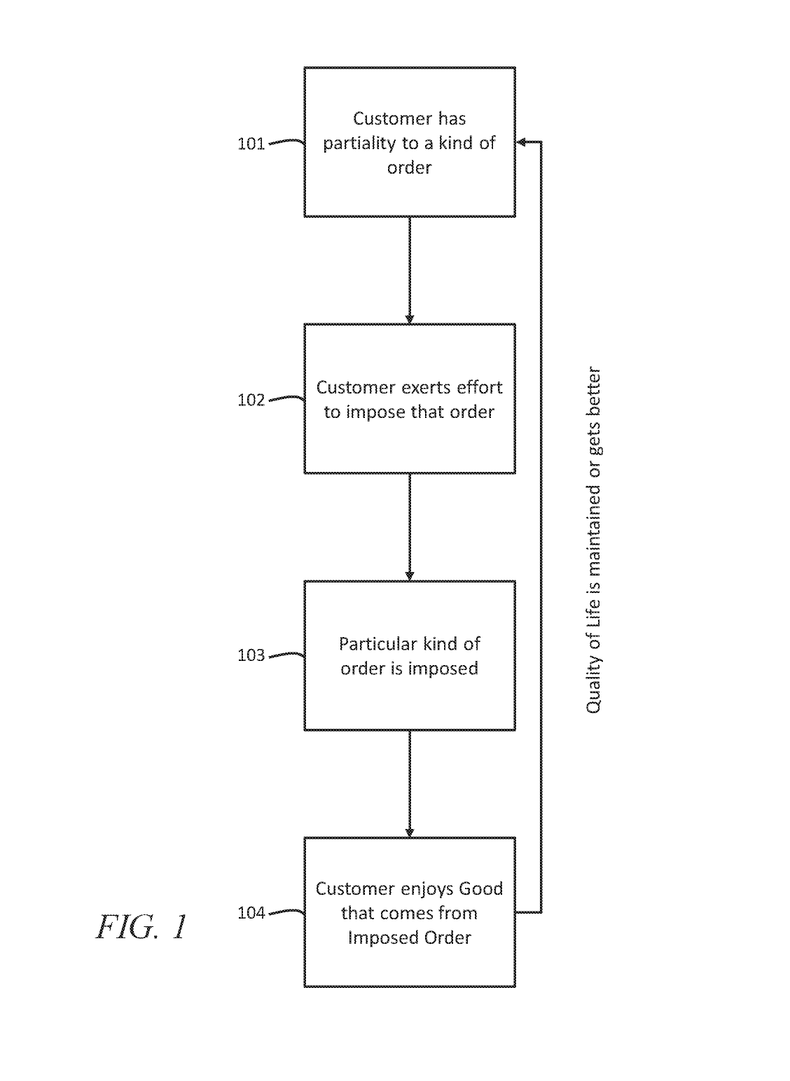

FIG. 1 provides a simple illustrative example in these regards. At block 101 it is understood that a particular person has a partiality (to a greater or lesser extent) to a particular kind of order. At block 102 that person willingly exerts effort to impose that order to thereby, at block 103, achieve an arrangement to which they are partial. And at block 104, this person appreciates the “good” that comes from successfully imposing the order to which they are partial, in effect establishing a positive feedback loop.

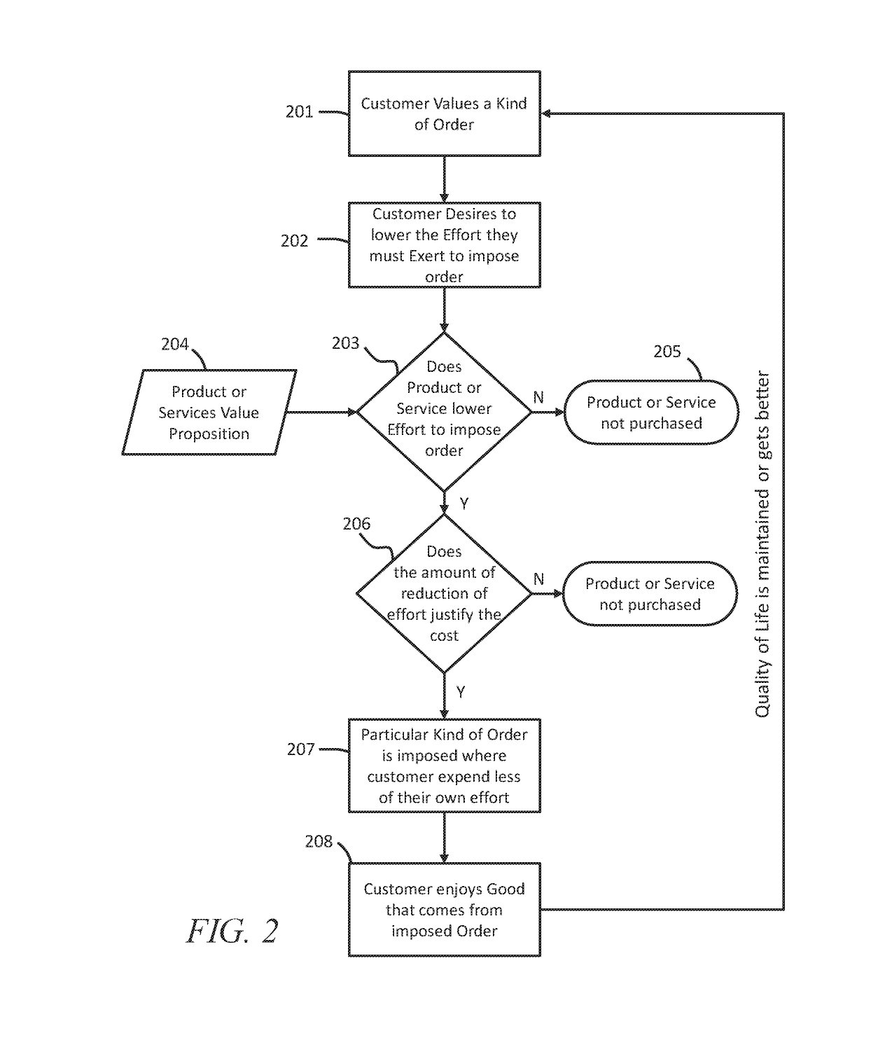

Understanding these partialities to particular kinds of order can be helpful to understanding how receptive a particular person may be to purchasing a given product or service. FIG. 2 provides a simple illustrative example in these regards. At block 201 it is understood that a particular person values a particular kind of order. At block 202 it is understood (or at least presumed) that this person wishes to lower the effort (or is at least receptive to lowering the effort) that they must personally exert to impose that order. At decision block 203 (and with access to information 204 regarding relevant products and or services) a determination can be made whether a particular product or service lowers the effort required by this person to impose the desired order. When such is not the case, it can be concluded that the person will not likely purchase such a product/service 205 (presuming better choices are available).

When the product or service does lower the effort required to impose the desired order, however, at block 206 a determination can be made as to whether the amount of the reduction of effort justifies the cost of purchasing and/or using the proffered product/service. If the cost does not justify the reduction of effort, it can again be concluded that the person will not likely purchase such a product/service 205. When the reduction of effort does justify the cost, however, this person may be presumed to want to purchase the product/service and thereby achieve the desired order (or at least an improvement with respect to that order) with less expenditure of their own personal effort (block 207) and thereby achieve, at block 208, corresponding enjoyment or appreciation of that result.

To facilitate such an analysis, the applicant has determined that factors pertaining to a person's partialities can be quantified and otherwise represented as corresponding vectors (where “vector” will be understood to refer to a geometric object/quantity having both an angle and a length/magnitude). These teachings will accommodate a variety of differing bases for such partialities including, for example, a person's values, affinities, aspirations, and preferences.

A value is a person's principle or standard of behavior, their judgment of what is important in life. A person's values represent their ethics, moral code, or morals and not a mere unprincipled liking or disliking of something. A person's value might be a belief in kind treatment of animals, a belief in cleanliness, a belief in the importance of personal care, and so forth.

An affinity is an attraction (or even a feeling of kinship) to a particular thing or activity. Examples including such a feeling towards a participatory sport such as golf or a spectator sport (including perhaps especially a particular team such as a particular professional or college football team), a hobby (such as quilting, model railroading, and so forth), one or more components of popular culture (such as a particular movie or television series, a genre of music or a particular musical performance group, or a given celebrity, for example), and so forth.

“Aspirations” refer to longer-range goals that require months or even years to reasonably achieve. As used herein “aspirations” does not include mere short term goals (such as making a particular meal tonight or driving to the store and back without a vehicular incident). The aspired-to goals, in turn, are goals pertaining to a marked elevation in one's core competencies (such as an aspiration to master a particular game such as chess, to achieve a particular articulated and recognized level of martial arts proficiency, or to attain a particular articulated and recognized level of cooking proficiency), professional status (such as an aspiration to receive a particular advanced education degree, to pass a professional examination such as a state Bar examination of a Certified Public Accountants examination, or to become Board certified in a particular area of medical practice), or life experience milestone (such as an aspiration to climb Mount Everest, to visit every state capital, or to attend a game at every major league baseball park in the United States). It will further be understood that the goal(s) of an aspiration is not something that can likely merely simply happen of its own accord; achieving an aspiration requires an intelligent effort to order one's life in a way that increases the likelihood of actually achieving the corresponding goal or goals to which that person aspires. One aspires to one day run their own business as versus, for example, merely hoping to one day win the state lottery.

A preference is a greater liking for one alternative over another or others. A person can prefer, for example, that their steak is cooked “medium” rather than other alternatives such as “rare” or “well done” or a person can prefer to play golf in the morning rather than in the afternoon or evening. Preferences can and do come into play when a given person makes purchasing decisions at a retail shopping facility. Preferences in these regards can take the form of a preference for a particular brand over other available brands or a preference for economy-sized packaging as versus, say, individual serving-sized packaging.

Values, affinities, aspirations, and preferences are not necessarily wholly unrelated. It is possible for a person's values, affinities, or aspirations to influence or even dictate their preferences in specific regards. For example, a person's moral code that values non-exploitive treatment of animals may lead them to prefer foods that include no animal-based ingredients and hence to prefer fruits and vegetables over beef and chicken offerings. As another example, a person's affinity for a particular musical group may lead them to prefer clothing that directly or indirectly references or otherwise represents their affinity for that group. As yet another example, a person's aspirations to become a Certified Public Accountant may lead them to prefer business-related media content.

While a value, affinity, or aspiration may give rise to or otherwise influence one or more corresponding preferences, however, is not to say that these things are all one and the same; they are not. For example, a preference may represent either a principled or an unprincipled liking for one thing over another, while a value is the principle itself. Accordingly, as used herein it will be understood that a partiality can include, in context, any one or more of a value-based, affinity-based, aspiration-based, and/or preference-based partiality unless one or more such features is specifically excluded per the needs of a given application setting.

Information regarding a given person's partialities can be acquired using any one or more of a variety of information-gathering and/or analytical approaches. By one simple approach, a person may voluntarily disclose information regarding their partialities (for example, in response to an online questionnaire or survey or as part of their social media presence). By another approach, the purchasing history for a given person can be analyzed to intuit the partialities that led to at least some of those purchases. By yet another approach demographic information regarding a particular person can serve as yet another source that sheds light on their partialities. Other ways that people reveal how they order their lives include but are not limited to: (1) their social networking profiles and behaviors (such as the things they “like” via Facebook, the images they post via Pinterest, informal and formal comments they initiate or otherwise provide in response to third-party postings including statements regarding their own personal long-term goals, the persons/topics they follow via Twitter, the photographs they publish via Picasso, and so forth); (2) their Internet surfing history; (3) their on-line or otherwise-published affinity-based memberships; (4) real-time (or delayed) information (such as steps walked, calories burned, geographic location, activities experienced, and so forth) from any of a variety of personal sensors (such as smart phones, tablet/pad-styled computers, fitness wearables, Global Positioning System devices, and so forth) and the so-called Internet of Things (such as smart refrigerators and pantries, entertainment and information platforms, exercise and sporting equipment, and so forth); (5) instructions, selections, and other inputs (including inputs that occur within augmented-reality user environments) made by a person via any of a variety of interactive interfaces (such as keyboards and cursor control devices, voice recognition, gesture-based controls, and eye tracking-based controls), and so forth.

The present teachings employ a vector-based approach to facilitate characterizing, representing, understanding, and leveraging such partialities to thereby identify products (and/or services) that will, for a particular corresponding consumer, provide for an improved or at least a favorable corresponding ordering for that consumer. Vectors are directed quantities that each have both a magnitude and a direction. Per the applicant's approach these vectors have a real, as versus a metaphorical, meaning in the sense of Newtonian physics. Generally speaking, each vector represents order imposed upon material space-time by a particular partiality.

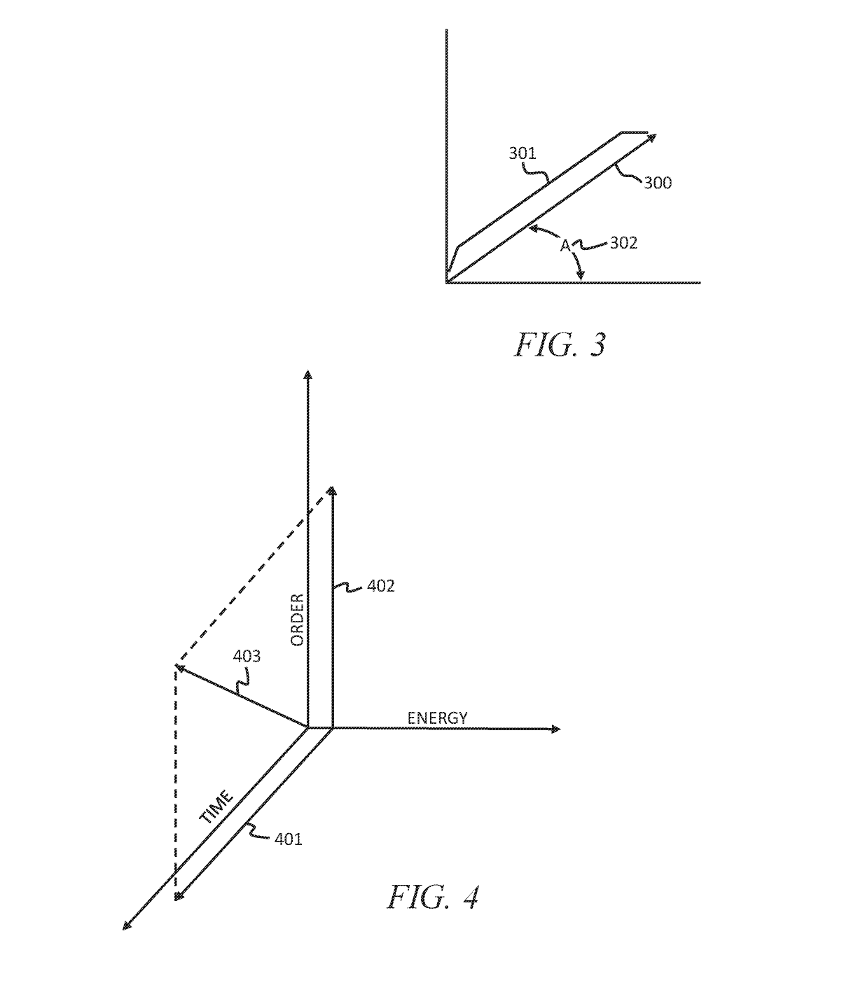

FIG. 3 provides some illustrative examples in these regards. By one approach the vector 300 has a corresponding magnitude 301 (i.e., length) that represents the magnitude of the strength of the belief in the good that comes from that imposed order (which belief, in turn, can be a function, relatively speaking, of the extent to which the order for this particular partiality is enabled and/or achieved). In this case, the greater the magnitude 301, the greater the strength of that belief and vice versa. Per another example, the vector 300 has a corresponding angle A 302 that instead represents the foregoing magnitude of the strength of the belief (and where, for example, an angle of 0° represents no such belief and an angle of 90° represents a highest magnitude in these regards, with other ranges being possible as desired).

Accordingly, a vector serving as a partiality vector can have at least one of a magnitude and an angle that corresponds to a magnitude of a particular person's belief in an amount of good that comes from an order associated with a particular partiality.

Applying force to displace an object with mass in the direction of a certain partiality-based order creates worth for a person who has that partiality. The resultant work (i.e., that force multiplied by the distance the object moves) can be viewed as a worth vector having a magnitude equal to the accomplished work and having a direction that represents the corresponding imposed order. If the resultant displacement results in more order of the kind that the person is partial to then the net result is a notion of “good.” This “good” is a real quantity that exists in meta-physical space much like work is a real quantity in material space. The link between the “good” in meta-physical space and the work in material space is that it takes work to impose order that has value.

In the context of a person, this effort can represent, quite literally, the effort that the person is willing to exert to be compliant with (or to otherwise serve) this particular partiality. For example, a person who values animal rights would have a large magnitude worth vector for this value if they exerted considerable physical effort towards this cause by, for example, volunteering at animal shelters or by attending protests of animal cruelty.

While these teachings will readily employ a direct measurement of effort such as work done or time spent, these teachings will also accommodate using an indirect measurement of effort such as expense; in particular, money. In many cases people trade their direct labor for payment. The labor may be manual or intellectual. While salaries and payments can vary significantly from one person to another, a same sense of effort applies at least in a relative sense.

As a very specific example in these regards, there are wristwatches that require a skilled craftsman over a year to make. The actual aggregated amount of force applied to displace the small components that comprise the wristwatch would be relatively very small. That said, the skilled craftsman acquired the necessary skill to so assemble the wristwatch over many years of applying force to displace thousands of little parts when assembly previous wristwatches. That experience, based upon a much larger aggregation of previously-exerted effort, represents a genuine part of the “effort” to make this particular wristwatch and hence is fairly considered as part of the wristwatch's worth.

The conventional forces working in each person's mind are typically more-or-less constantly evaluating the value propositions that correspond to a path of least effort to thereby order their lives towards the things they value. A key reason that happens is because the actual ordering occurs in material space and people must exert real energy in pursuit of their desired ordering. People therefore naturally try to find the path with the least real energy expended that still moves them to the valued order. Accordingly, a trusted value proposition that offers a reduction of real energy will be embraced as being “good” because people will tend to be partial to anything that lowers the real energy they are required to exert while remaining consistent with their partialities.

FIG. 4 presents a space graph that illustrates many of the foregoing points. A first vector 401 represents the time required to make such a wristwatch while a second vector 402 represents the order associated with such a device (in this case, that order essentially represents the skill of the craftsman). These two vectors 401 and 402 in turn sum to form a third vector 403 that constitutes a value vector for this wristwatch. This value vector 403, in turn, is offset with respect to energy (i.e., the energy associated with manufacturing the wristwatch).

A person partial to precision and/or to physically presenting an appearance of success and status (and who presumably has the wherewithal) may, in turn, be willing to spend $100,000 for such a wristwatch. A person able to afford such a price, of course, may themselves be skilled at imposing a certain kind of order that other persons are partial to such that the amount of physical work represented by each spent dollar is small relative to an amount of dollars they receive when exercising their skill(s). (Viewed another way, wearing an expensive wristwatch may lower the effort required for such a person to communicate that their own personal success comes from being highly skilled in a certain order of high worth.)

Generally speaking, all worth comes from imposing order on the material space-time. The worth of a particular order generally increases as the skill required to impose the order increases. Accordingly, unskilled labor may exchange $10 for every hour worked where the work has a high content of unskilled physical labor while a highly-skilled data scientist may exchange $75 for every hour worked with very little accompanying physical effort.

Consider a simple example where both of these laborers are partial to a well-ordered lawn and both have a corresponding partiality vector in those regards with a same magnitude. To observe that partiality the unskilled laborer may own an inexpensive push power lawn mower that this person utilizes for an hour to mow their lawn. The data scientist, on the other hand, pays someone else $75 in this example to mow their lawn. In both cases these two individuals traded one hour of worth creation to gain the same worth (to them) in the form of a well-ordered lawn; the unskilled laborer in the form of direct physical labor and the data scientist in the form of money that required one hour of their specialized effort to earn.

This same vector-based approach can also represent various products and services. This is because products and services have worth (or not) because they can remove effort (or fail to remove effort) out of the customer's life in the direction of the order to which the customer is partial. In particular, a product has a perceived effort embedded into each dollar of cost in the same way that the customer has an amount of perceived effort embedded into each dollar earned. A customer has an increased likelihood of responding to an exchange of value if the vectors for the product and the customer's partiality are directionally aligned and where the magnitude of the vector as represented in monetary cost is somewhat greater than the worth embedded in the customer's dollar.

Put simply, the magnitude (and/or angle) of a partiality vector for a person can represent, directly or indirectly, a corresponding effort the person is willing to exert to pursue that partiality. There are various ways by which that value can be determined. As but one non-limiting example in these regards, the magnitude/angle V of a particular partiality vector can be expressed as:

$$V = [ \begin{matrix}{X}_{1} \\ ⋮ \\ {X}_{n }\end{matrix} ] [ \begin{matrix}{W}_{1} & … & {W}_{n}\end{matrix} ]$$

where X refers to any of a variety of inputs (such as those described above) that can impact the characterization of a particular partiality (and where these teachings will accommodate either or both subjective and objective inputs as desired) and W refers to weighting factors that are appropriately applied the foregoing input values (and where, for example, these weighting factors can have values that themselves reflect a particular person's consumer personality or otherwise as desired and can be static or dynamically valued in practice as desired).

In the context of a product (or service) the magnitude/angle of the corresponding vector can represent the reduction of effort that must be exerted when making use of this product to pursue that partiality, the effort that was expended in order to create the product/service, the effort that the person perceives can be personally saved while nevertheless promoting the desired order, and/or some other corresponding effort. Taken as a whole the sum of all the vectors must be perceived to increase the overall order to be considered a good product/service.

It may be noted that while reducing effort provides a very useful metric in these regards, it does not necessarily follow that a given person will always gravitate to that which most reduces effort in their life. This is at least because a given person's values (for example) will establish a baseline against which a person may eschew some goods/services that might in fact lead to a greater overall reduction of effort but which would conflict, perhaps fundamentally, with their values. As a simple illustrative example, a given person might value physical activity. Such a person could experience reduced effort (including effort represented via monetary costs) by simply sitting on their couch, but instead will pursue activities that involve that valued physical activity. That said, however, the goods and services that such a person might acquire in support of their physical activities are still likely to represent increased order in the form of reduced effort where that makes sense. For example, a person who favors rock climbing might also favor rock climbing clothing and supplies that render that activity safer to thereby reduce the effort required to prevent disorder as a consequence of a fall (and consequently increasing the good outcome of the rock climber's quality experience).

By forming reliable partiality vectors for various individuals and corresponding product characterization vectors for a variety of products and/or services, these teachings provide a useful and reliable way to identify products/services that accord with a given person's own partialities (whether those partialities are based on their values, their affinities, their preferences, or otherwise).

It is of course possible that partiality vectors may not be available yet for a given person due to a lack of sufficient specific source information from or regarding that person. In this case it may nevertheless be possible to use one or more partiality vector templates that generally represent certain groups of people that fairly include this particular person. For example, if the person's gender, age, academic status/achievements, and/or postal code are known it may be useful to utilize a template that includes one or more partiality vectors that represent some statistical average or norm of other persons matching those same characterizing parameters. (Of course, while it may be useful to at least begin to employ these teachings with certain individuals by using one or more such templates, these teachings will also accommodate modifying (perhaps significantly and perhaps quickly) such a starting point over time as part of developing a more personal set of partiality vectors that are specific to the individual.) A variety of templates could be developed based, for example, on professions, academic pursuits and achievements, nationalities and/or ethnicities, characterizing hobbies, and the like.

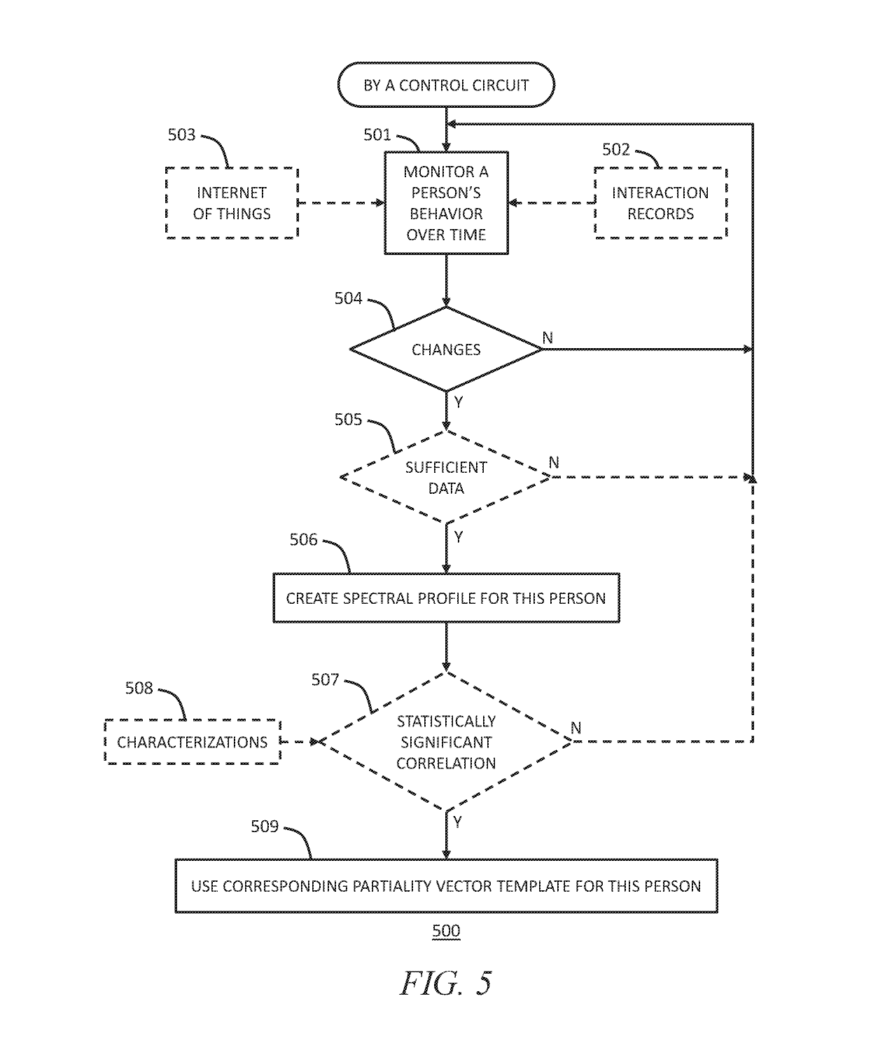

FIG. 5 presents a process 500 that illustrates yet another approach in these regards. For the sake of an illustrative example it will be presumed here that a control circuit of choice (with useful examples in these regards being presented further below) carries out one or more of the described steps/actions.

At block 501 the control circuit monitors a person's behavior over time. The range of monitored behaviors can vary with the individual and the application setting. By one approach, only behaviors that the person has specifically approved for monitoring are so monitored.

As one example in these regards, this monitoring can be based, in whole or in part, upon interaction records 502 that reflect or otherwise track, for example, the monitored person's purchases. This can include specific items purchased by the person, from whom the items were purchased, where the items were purchased, how the items were purchased (for example, at a bricks-and-mortar physical retail shopping facility or via an on-line shopping opportunity), the price paid for the items, and/or which items were returned and when), and so forth.

As another example in these regards the interaction records 502 can pertain to the social networking behaviors of the monitored person including such things as their “likes,” their posted comments, images, and tweets, affinity group affiliations, their on-line profiles, their playlists and other indicated “favorites,” and so forth. Such information can sometimes comprise a direct indication of a particular partiality or, in other cases, can indirectly point towards a particular partiality and/or indicate a relative strength of the person's partiality.

Other interaction records of potential interest include but are not limited to registered political affiliations and activities, credit reports, military-service history, educational and employment history, and so forth.

As another example, in lieu of the foregoing or in combination therewith, this monitoring can be based, in whole or in part, upon sensor inputs from the Internet of Things (IOT) 503. The Internet of Things refers to the Internet-based inter-working of a wide variety of physical devices including but not limited to wearable or carriable devices, vehicles, buildings, and other items that are embedded with electronics, software, sensors, network connectivity, and sometimes actuators that enable these objects to collect and exchange data via the Internet. In particular, the Internet of Things allows people and objects pertaining to people to be sensed and corresponding information to be transferred to remote locations via intervening network infrastructure. Some experts estimate that the Internet of Things will consist of almost 50 billion such objects by 2020. (Further description in these regards appears further herein.)

Depending upon what sensors a person encounters, information can be available regarding a person's travels, lifestyle, calorie expenditure over time, diet, habits, interests and affinities, choices and assumed risks, and so forth. This process 500 will accommodate either or both real-time or non-real time access to such information as well as either or both push and pull-based paradigms.

By monitoring a person's behavior over time a general sense of that person's daily routine can be established (sometimes referred to herein as a routine experiential base state). As a very simple illustrative example, a routine experiential base state can include a typical daily event timeline for the person that represents typical locations that the person visits and/or typical activities in which the person engages. The timeline can indicate those activities that tend to be scheduled (such as the person's time at their place of employment or their time spent at their child's sports practices) as well as visits/activities that are normal for the person though not necessarily undertaken with strict observance to a corresponding schedule (such as visits to local stores, movie theaters, and the homes of nearby friends and relatives).

At block 504 this process 500 provides for detecting changes to that established routine. These teachings are highly flexible in these regards and will accommodate a wide variety of “changes.” Some illustrative examples include but are not limited to changes with respect to a person's travel schedule, destinations visited or time spent at a particular destination, the purchase and/or use of new and/or different products or services, a subscription to a new magazine, a new Rich Site Summary (RSS) feed or a subscription to a new blog, a new “friend” or “connection” on a social networking site, a new person, entity, or cause to follow on a Twitter-like social networking service, enrollment in an academic program, and so forth.

Upon detecting a change, at optional block 505 this process 500 will accommodate assessing whether the detected change constitutes a sufficient amount of data to warrant proceeding further with the process. This assessment can comprise, for example, assessing whether a sufficient number (i.e., a predetermined number) of instances of this particular detected change have occurred over some predetermined period of time. As another example, this assessment can comprise assessing whether the specific details of the detected change are sufficient in quantity and/or quality to warrant further processing. For example, merely detecting that the person has not arrived at their usual 6 PM-Wednesday dance class may not be enough information, in and of itself, to warrant further processing, in which case the information regarding the detected change may be discarded or, in the alternative, cached for further consideration and use in conjunction or aggregation with other, later-detected changes.

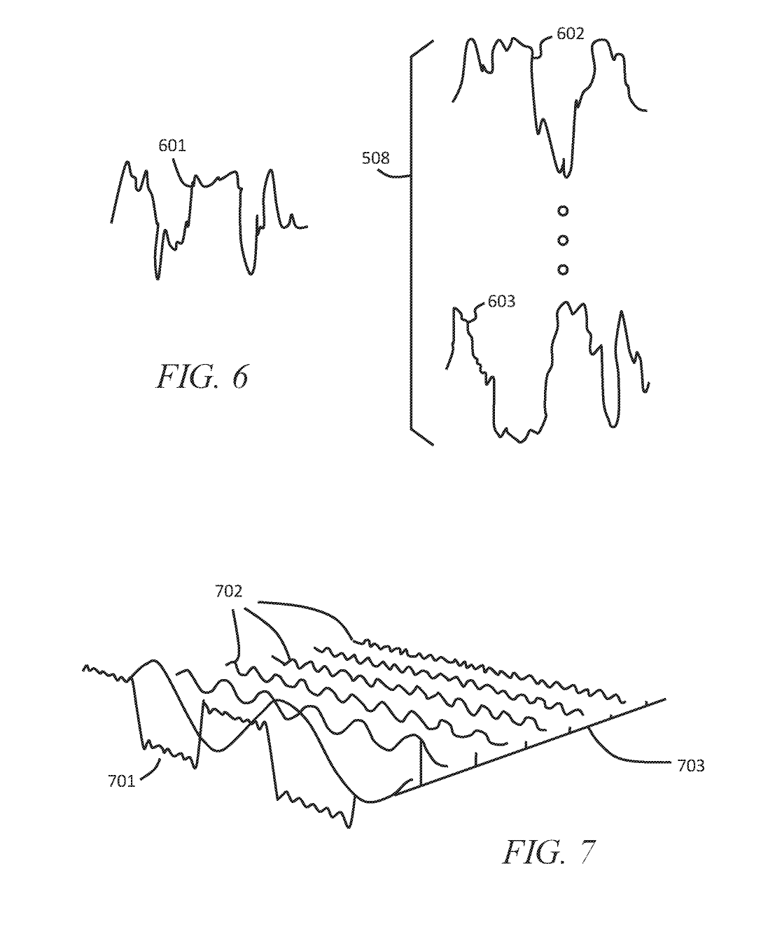

At block 507 this process 500 uses these detected changes to create a spectral profile for the monitored person. FIG. 6 provides an illustrative example in these regards with the spectral profile denoted by reference numeral 601. In this illustrative example the spectral profile 601 represents changes to the person's behavior over a given period of time (such as an hour, a day, a week, or some other temporal window of choice). Such a spectral profile can be as multidimensional as may suit the needs of a given application setting.

At optional block 507 this process 500 then provides for determining whether there is a statistically significant correlation between the aforementioned spectral profile and any of a plurality of like characterizations 508. The like characterizations 508 can comprise, for example, spectral profiles that represent an average of groupings of people who share many of the same (or all of the same) identified partialities. As a very simple illustrative example in these regards, a first such characterization 602 might represent a composite view of a first group of people who have three similar partialities but a dissimilar fourth partiality while another of the characterizations 603 might represent a composite view of a different group of people who share all four partialities.

The aforementioned “statistically significant” standard can be selected and/or adjusted to suit the needs of a given application setting. The scale or units by which this measurement can be assessed can be any known, relevant scale/unit including, but not limited to, scales such as standard deviations, cumulative percentages, percentile equivalents, Z-scores, T-scores, standard nines, and percentages in standard nines. Similarly, the threshold by which the level of statistical significance is measured/assessed can be set and selected as desired. By one approach the threshold is static such that the same threshold is employed regardless of the circumstances. By another approach the threshold is dynamic and can vary with such things as the relative size of the population of people upon which each of the characterizations 508 are based and/or the amount of data and/or the duration of time over which data is available for the monitored person.

Referring now to FIG. 7, by one approach the selected characterization (denoted by reference numeral 701 in this figure) comprises an activity profile over time of one or more human behaviors. Examples of behaviors include but are not limited to such things as repeated purchases over time of particular commodities, repeated visits over time to particular locales such as certain restaurants, retail outlets, athletic or entertainment facilities, and so forth, and repeated activities over time such as floor cleaning, dish washing, car cleaning, cooking, volunteering, and so forth. Those skilled in the art will understand and appreciate, however, that the selected characterization is not, in and of itself, demographic data (as described elsewhere herein).

More particularly, the characterization 701 can represent (in this example, for a plurality of different behaviors) each instance over the monitored/sampled period of time when the monitored/represented person engages in a particular represented behavior (such as visiting a neighborhood gym, purchasing a particular product (such as a consumable perishable or a cleaning product), interacts with a particular affinity group via social networking, and so forth). The relevant overall time frame can be chosen as desired and can range in a typical application setting from a few hours or one day to many days, weeks, or even months or years. (It will be understood by those skilled in the art that the particular characterization shown in FIG. 7 is intended to serve an illustrative purpose and does not necessarily represent or mimic any particular behavior or set of behaviors).

Generally speaking it is anticipated that many behaviors of interest will occur at regular or somewhat regular intervals and hence will have a corresponding frequency or periodicity of occurrence. For some behaviors that frequency of occurrence may be relatively often (for example, oral hygiene events that occur at least once, and often multiple times each day) while other behaviors (such as the preparation of a holiday meal) may occur much less frequently (such as only once, or only a few times, each year). For at least some behaviors of interest that general (or specific) frequency of occurrence can serve as a significant indication of a person's corresponding partialities.

By one approach, these teachings will accommodate detecting and timestamping each and every event/activity/behavior or interest as it happens. Such an approach can be memory intensive and require considerable supporting infrastructure.

The present teachings will also accommodate, however, using any of a variety of sampling periods in these regards. In some cases, for example, the sampling period per se may be one week in duration. In that case, it may be sufficient to know that the monitored person engaged in a particular activity (such as cleaning their car) a certain number of times during that week without known precisely when, during that week, the activity occurred. In other cases it may be appropriate or even desirable, to provide greater granularity in these regards. For example, it may be better to know which days the person engaged in the particular activity or even the particular hour of the day. Depending upon the selected granularity/resolution, selecting an appropriate sampling window can help reduce data storage requirements (and/or corresponding analysis/processing overhead requirements).

Although a given person's behaviors may not, strictly speaking, be continuous waves (as shown in FIG. 7) in the same sense as, for example, a radio or acoustic wave, it will nevertheless be understood that such a behavioral characterization 701 can itself be broken down into a plurality of sub-waves 702 that, when summed together, equal or at least approximate to some satisfactory degree the behavioral characterization 701 itself (The more-discrete and sometimes less-rigidly periodic nature of the monitored behaviors may introduce a certain amount of error into the corresponding sub-waves. There are various mathematically satisfactory ways by which such error can be accommodated including by use of weighting factors and/or expressed tolerances that correspond to the resultant sub-waves.)

It should also be understood that each such sub-wave can often itself be associated with one or more corresponding discrete partialities. For example, a partiality reflecting concern for the environment may, in turn, influence many of the included behavioral events (whether they are similar or dissimilar behaviors or not) and accordingly may, as a sub-wave, comprise a relatively significant contributing factor to the overall set of behaviors as monitored over time. These sub-waves (partialities) can in turn be clearly revealed and presented by employing a transform (such as a Fourier transform) of choice to yield a spectral profile 703 wherein the X axis represents frequency and the Y axis represents the magnitude of the response of the monitored person at each frequency/sub-wave of interest.

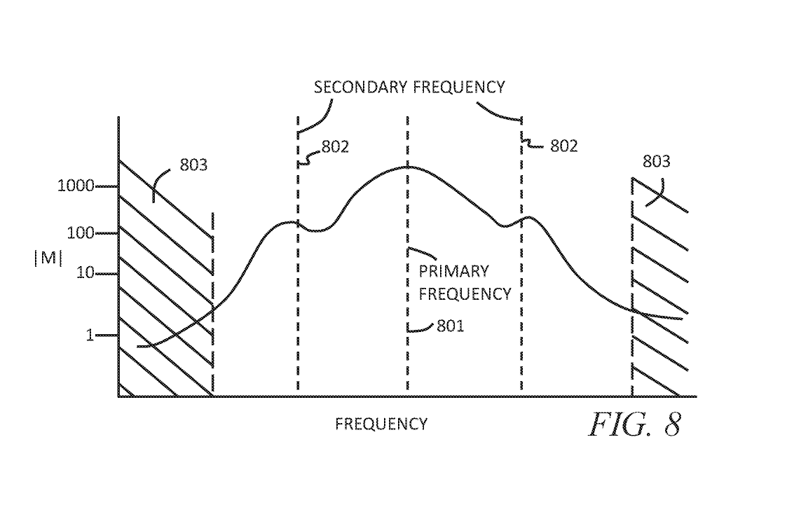

This spectral response of a given individual—which is generated from a time series of events that reflect/track that person's behavior—yields frequency response characteristics for that person that are analogous to the frequency response characteristics of physical systems such as, for example, an analog or digital filter or a second order electrical or mechanical system. Referring to FIG. 8, for many people the spectral profile of the individual person will exhibit a primary frequency 801 for which the greatest response (perhaps many orders of magnitude greater than other evident frequencies) to life is exhibited and apparent. In addition, the spectral profile may also possibly identify one or more secondary frequencies 802 above and/or below that primary frequency 801. (It may be useful in many application settings to filter out more distant frequencies 803 having considerably lower magnitudes because of a reduced likelihood of relevance and/or because of a possibility of error in those regards; in effect, these lower-magnitude signals constitute noise that such filtering can remove from consideration.)

As noted above, the present teachings will accommodate using sampling windows of varying size. By one approach the frequency of events that correspond to a particular partiality can serve as a basis for selecting a particular sampling rate to use when monitoring for such events. For example, Nyquist-based sampling rules (which dictate sampling at a rate at least twice that of the frequency of the signal of interest) can lead one to choose a particular sampling rate (and the resultant corresponding sampling window size).

As a simple illustration, if the activity of interest occurs only once a week, then using a sampling of half-a-week and sampling twice during the course of a given week will adequately capture the monitored event. If the monitored person's behavior should change, a corresponding change can be automatically made. For example, if the person in the foregoing example begins to engage in the specified activity three times a week, the sampling rate can be switched to six times per week (in conjunction with a sampling window that is resized accordingly).

By one approach, the sampling rate can be selected and used on a partiality-by-partiality basis. This approach can be especially useful when different monitoring modalities are employed to monitor events that correspond to different partialities. If desired, however, a single sampling rate can be employed and used for a plurality (or even all) partialities/behaviors. In that case, it can be useful to identify the behavior that is exemplified most often (i.e., that behavior which has the highest frequency) and then select a sampling rate that is at least twice that rate of behavioral realization, as that sampling rate will serve well and suffice for both that highest-frequency behavior and all lower-frequency behaviors as well.

It can be useful in many application settings to assume that the foregoing spectral profile of a given person is an inherent and inertial characteristic of that person and that this spectral profile, in essence, provides a personality profile of that person that reflects not only how but why this person responds to a variety of life experiences. More importantly, the partialities expressed by the spectral profile for a given person will tend to persist going forward and will not typically change significantly in the absence of some powerful external influence (including but not limited to significant life events such as, for example, marriage, children, loss of job, promotion, and so forth).

In any event, by knowing a priori the particular partialities (and corresponding strengths) that underlie the particular characterization 701, those partialities can be used as an initial template for a person whose own behaviors permit the selection of that particular characterization 701. In particular, those particularities can be used, at least initially, for a person for whom an amount of data is not otherwise available to construct a similarly rich set of partiality information.

As a very specific and non-limiting example, per these teachings the choice to make a particular product can include consideration of one or more value systems of potential customers. When considering persons who value animal rights, a product conceived to cater to that value proposition may require a corresponding exertion of additional effort to order material space-time such that the product is made in a way that (A) does not harm animals and/or (even better) (B) improves life for animals (for example, eggs obtained from free range chickens). The reason a person exerts effort to order material space-time is because they believe it is good to do and/or not good to not do so. When a person exerts effort to do good (per their personal standard of “good”) and if that person believes that a particular order in material space-time (that includes the purchase of a particular product) is good to achieve, then that person will also believe that it is good to buy as much of that particular product (in order to achieve that good order) as their finances and needs reasonably permit (all other things being equal).

The aforementioned additional effort to provide such a product can (typically) convert to a premium that adds to the price of that product. A customer who puts out extra effort in their life to value animal rights will typically be willing to pay that extra premium to cover that additional effort exerted by the company. By one approach a magnitude that corresponds to the additional effort exerted by the company can be added to the person's corresponding value vector because a product or service has worth to the extent that the product/service allows a person to order material space-time in accordance with their own personal value system while allowing that person to exert less of their own effort in direct support of that value (since money is a scalar form of effort).

By one approach there can be hundreds or even thousands of identified partialities. In this case, if desired, each product/service of interest can be assessed with respect to each and every one of these partialities and a corresponding partiality vector formed to thereby build a collection of partiality vectors that collectively characterize the product/service. As a very simple example in these regards, a given laundry detergent might have a cleanliness partiality vector with a relatively high magnitude (representing the effectiveness of the detergent), a ecology partiality vector that might be relatively low or possibly even having a negative magnitude (representing an ecologically disadvantageous effect of the detergent post usage due to increased disorder in the environment), and a simple-life partiality vector with only a modest magnitude (representing the relative ease of use of the detergent but also that the detergent presupposes that the user has a modern washing machine). Other partiality vectors for this detergent, representing such things as nutrition or mental acuity, might have magnitudes of zero.

As mentioned above, these teachings can accommodate partiality vectors having a negative magnitude. Consider, for example, a partiality vector representing a desire to order things to reduce one's so-called carbon footprint. A magnitude of zero for this vector would indicate a completely neutral effect with respect to carbon emissions while any positive-valued magnitudes would represent a net reduction in the amount of carbon in the atmosphere, hence increasing the ability of the environment to be ordered. Negative magnitudes would represent the introduction of carbon emissions that increases disorder of the environment (for example, as a result of manufacturing the product, transporting the product, and/or using the product)

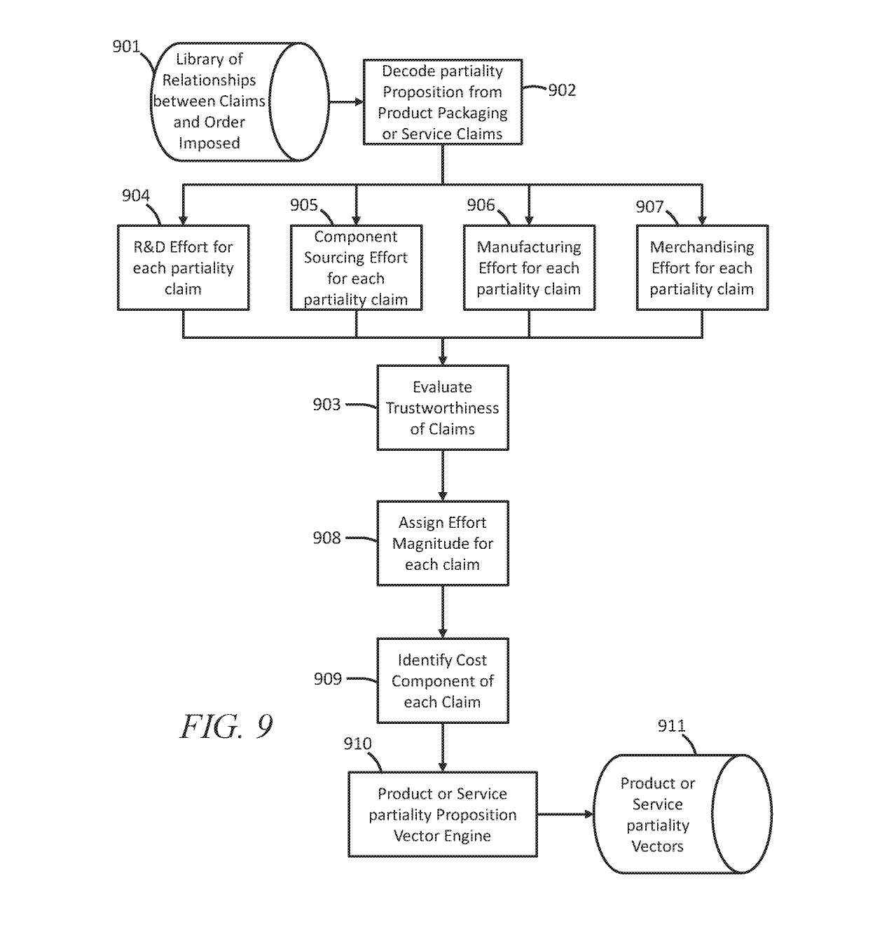

FIG. 9 presents one non-limiting illustrative example in these regards. The illustrated process presumes the availability of a library 901 of correlated relationships between product/service claims and particular imposed orders. Examples of product/service claims include such things as claims that a particular product results in cleaner laundry or household surfaces, or that a particular product is made in a particular political region (such as a particular state or country), or that a particular product is better for the environment, and so forth. The imposed orders to which such claims are correlated can reflect orders as described above that pertain to corresponding partialities.

At block 902 this process provides for decoding one or more partiality propositions from specific product packaging (or service claims). For example, the particular textual/graphics-based claims presented on the packaging of a given product can be used to access the aforementioned library 901 to identify one or more corresponding imposed orders from which one or more corresponding partialities can then be identified.

At block 903 this process provides for evaluating the trustworthiness of the aforementioned claims. This evaluation can be based upon any one or more of a variety of data points as desired. FIG. 9 illustrates four significant possibilities in these regards. For example, at block 904 an actual or estimated research and development effort can be quantified for each claim pertaining to a partiality. At block 905 an actual or estimated component sourcing effort for the product in question can be quantified for each claim pertaining to a partiality. At block 906 an actual or estimated manufacturing effort for the product in question can be quantified for each claim pertaining to a partiality. And at block 907 an actual or estimated merchandising effort for the product in question can be quantified for each claim pertaining to a partiality.

If desired, a product claim lacking sufficient trustworthiness may simply be excluded from further consideration. By another approach the product claim can remain in play but a lack of trustworthiness can be reflected, for example, in a corresponding partiality vector direction or magnitude for this particular product.

At block 908 this process provides for assigning an effort magnitude for each evaluated product/service claim. That effort can constitute a one-dimensional effort (reflecting, for example, only the manufacturing effort) or can constitute a multidimensional effort that reflects, for example, various categories of effort such as the aforementioned research and development effort, component sourcing effort, manufacturing effort, and so forth.

At block 909 this process provides for identifying a cost component of each claim, this cost component representing a monetary value. At block 910 this process can use the foregoing information with a product/service partiality propositions vector engine to generate a library 911 of one or more corresponding partiality vectors for the processed products/services. Such a library can then be used as described herein in conjunction with partiality vector information for various persons to identify, for example, products/services that are well aligned with the partialities of specific individuals.

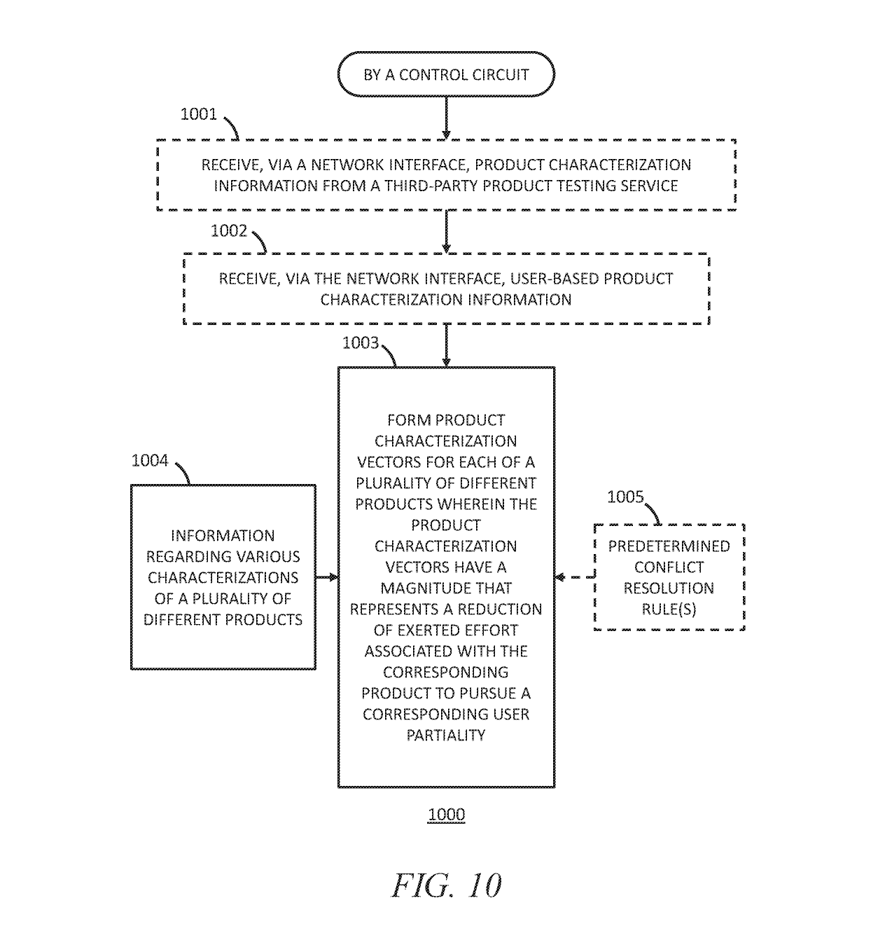

FIG. 10 provides another illustrative example in these same regards and may be employed in lieu of the foregoing or in total or partial combination therewith. Generally speaking, this process 1000 serves to facilitate the formation of product characterization vectors for each of a plurality of different products where the magnitude of the vector length (and/or the vector angle) has a magnitude that represents a reduction of exerted effort associated with the corresponding product to pursue a corresponding user partiality.

By one approach, and as illustrated in FIG. 10, this process 1000 can be carried out by a control circuit of choice. Specific examples of control circuits are provided elsewhere herein.

As described further herein in detail, this process 1000 makes use of information regarding various characterizations of a plurality of different products. These teachings are highly flexible in practice and will accommodate a wide variety of possible information sources and types of information. By one optional approach, and as shown at optional block 1001, the control circuit can receive (for example, via a corresponding network interface of choice) product characterization information from a third-party product testing service. The magazine/web resource Consumers Report provides one useful example in these regards. Such a resource provides objective content based upon testing, evaluation, and comparisons (and sometimes also provides subjective content regarding such things as aesthetics, ease of use, and so forth) and this content, provided as-is or pre-processed as desired, can readily serve as useful third-party product testing service product characterization information.

As another example, any of a variety of product-testing blogs that are published on the Internet can be similarly accessed and the product characterization information available at such resources harvested and received by the control circuit. (The expression “third party” will be understood to refer to an entity other than the entity that operates/controls the control circuit and other than the entity that provides the corresponding product itself.)

As another example, and as illustrated at optional block 1002, the control circuit can receive (again, for example, via a network interface of choice) user-based product characterization information. Examples in these regards include but are not limited to user reviews provided on-line at various retail sites for products offered for sale at such sites. The reviews can comprise metricized content (for example, a rating expressed as a certain number of stars out of a total available number of stars, such as 3 stars out of 5 possible stars) and/or text where the reviewers can enter their objective and subjective information regarding their observations and experiences with the reviewed products. In this case, “user-based” will be understood to refer to users who are not necessarily professional reviewers (though it is possible that content from such persons may be included with the information provided at such a resource) but who presumably purchased the product being reviewed and who have personal experience with that product that forms the basis of their review. By one approach the resource that offers such content may constitute a third party as defined above, but these teachings will also accommodate obtaining such content from a resource operated or sponsored by the enterprise that controls/operates this control circuit.

In any event, this process 1000 provides for accessing (see block 1004) information regarding various characterizations of each of a plurality of different products. This information 1004 can be gleaned as described above and/or can be obtained and/or developed using other resources as desired. As one illustrative example in these regards, the manufacturer and/or distributor of certain products may source useful content in these regards.

These teachings will accommodate a wide variety of information sources and types including both objective characterizing and/or subjective characterizing information for the aforementioned products.

Examples of objective characterizing information include, but are not limited to, ingredients information (i.e., specific components/materials from which the product is made), manufacturing locale information (such as country of origin, state of origin, municipality of origin, region of origin, and so forth), efficacy information (such as metrics regarding the relative effectiveness of the product to achieve a particular end-use result), cost information (such as per product, per ounce, per application or use, and so forth), availability information (such as present in-store availability, on-hand inventory availability at a relevant distribution center, likely or estimated shipping date, and so forth), environmental impact information (regarding, for example, the materials from which the product is made, one or more manufacturing processes by which the product is made, environmental impact associated with use of the product, and so forth), and so forth.

Examples of subjective characterizing information include but are not limited to user sensory perception information (regarding, for example, heaviness or lightness, speed of use, effort associated with use, smell, and so forth), aesthetics information (regarding, for example, how attractive or unattractive the product is in appearance, how well the product matches or accords with a particular design paradigm or theme, and so forth), trustworthiness information (regarding, for example, user perceptions regarding how likely the product is perceived to accomplish a particular purpose or to avoid causing a particular collateral harm), trendiness information, and so forth.

This information 1004 can be curated (or not), filtered, sorted, weighted (in accordance with a relative degree of trust, for example, accorded to a particular source of particular information), and otherwise categorized and utilized as desired. As one simple example in these regards, for some products it may be desirable to only use relatively fresh information (i.e., information not older than some specific cut-off date) while for other products it may be acceptable (or even desirable) to use, in lieu of fresh information or in combination therewith, relatively older information. As another simple example, it may be useful to use only information from one particular geographic region to characterize a particular product and to therefore not use information from other geographic regions.

At block 1003 the control circuit uses the foregoing information 1004 to form product characterization vectors for each of the plurality of different products. By one approach these product characterization vectors have a magnitude (for the length of the vector and/or the angle of the vector) that represents a reduction of exerted effort associated with the corresponding product to pursue a corresponding user partiality (as is otherwise discussed herein).

It is possible that a conflict will become evident as between various ones of the aforementioned items of information 1004. In particular, the available characterizations for a given product may not all be the same or otherwise in accord with one another. In some cases it may be appropriate to literally or effectively calculate and use an average to accommodate such a conflict. In other cases it may be useful to use one or more other predetermined conflict resolution rules 1005 to automatically resolve such conflicts when forming the aforementioned product characterization vectors.

These teachings will accommodate any of a variety of rules in these regards. By one approach, for example, the rule can be based upon the age of the information (where, for example the older (or newer, if desired) data is preferred or weighted more heavily than the newer (or older, if desired) data. By another approach, the rule can be based upon a number of user reviews upon which the user-based product characterization information is based (where, for example, the rule specifies that whichever user-based product characterization information is based upon a larger number of user reviews will prevail in the event of a conflict). By another approach, the rule can be based upon information regarding historical accuracy of information from a particular information source (where, for example, the rule specifies that information from a source with a better historical record of accuracy shall prevail over information from a source with a poorer historical record of accuracy in the event of a conflict).

By yet another approach, the rule can be based upon social media. For example, social media-posted reviews may be used as a tie-breaker in the event of a conflict between other more-favored sources. By another approach, the rule can be based upon a trending analysis. And by yet another approach the rule can be based upon the relative strength of brand awareness for the product at issue (where, for example, the rule specifies resolving a conflict in favor of a more favorable characterization when dealing with a product from a strong brand that evidences considerable consumer goodwill and trust).

It will be understood that the foregoing examples are intended to serve an illustrative purpose and are not offered as an exhaustive listing in these regards. It will also be understood that any two or more of the foregoing rules can be used in combination with one another to resolve the aforementioned conflicts.

By one approach the aforementioned product characterization vectors are formed to serve as a universal characterization of a given product. By another approach, however, the aforementioned information 1004 can be used to form product characterization vectors for a same characterization factor for a same product to thereby correspond to different usage circumstances of that same product. Those different usage circumstances might comprise, for example, different geographic regions of usage, different levels of user expertise (where, for example, a skilled, professional user might have different needs and expectations for the product than a casual, lay user), different levels of expected use, and so forth. In particular, the different vectorized results for a same characterization factor for a same product may have differing magnitudes from one another to correspond to different amounts of reduction of the exerted effort associated with that product under the different usage circumstances.

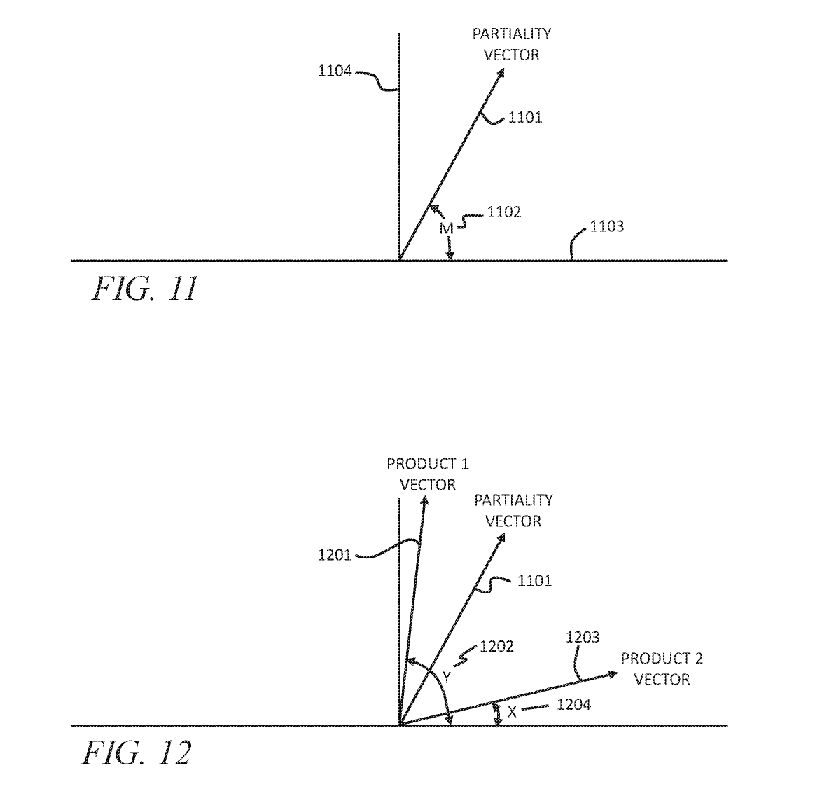

As noted above, the magnitude corresponding to a particular partiality vector for a particular person can be expressed by the angle of that partiality vector. FIG. 11 provides an illustrative example in these regards. In this example the partiality vector 1101 has an angle M 1102 (and where the range of available positive magnitudes range from a minimal magnitude represented by 0° (as denoted by reference numeral 1103) to a maximum magnitude represented by 90° (as denoted by reference numeral 1104)). Accordingly, the person to whom this partiality vector 1001 pertains has a relatively strong (but not absolute) belief in an amount of good that comes from an order associated with that partiality.

FIG. 12, in turn, presents that partiality vector 1101 in context with the product characterization vectors 1201 and 1203 for a first product and a second product, respectively. In this example the product characterization vector 1201 for the first product has an angle Y 1202 that is greater than the angle M 1102 for the aforementioned partiality vector 1101 by a relatively small amount while the product characterization vector 1203 for the second product has an angle X 1204 that is considerably smaller than the angle M 1102 for the partiality vector 1101.

Since, in this example, the angles of the various vectors represent the magnitude of the person's specified partiality or the extent to which the product aligns with that partiality, respectively, vector dot product calculations can serve to help identify which product best aligns with this partiality. Such an approach can be particularly useful when the lengths of the vectors are allowed to vary as a function of one or more parameters of interest. As those skilled in the art will understand, a vector dot product is an algebraic operation that takes two equal-length sequences of numbers (in this case, coordinate vectors) and returns a single number.

This operation can be defined either algebraically or geometrically. Algebraically, it is the sum of the products of the corresponding entries of the two sequences of numbers. Geometrically, it is the product of the Euclidean magnitudes of the two vectors and the cosine of the angle between them. The result is a scalar rather than a vector. As regards the present illustrative example, the resultant scaler value for the vector dot product of the product 1 vector 1201 with the partiality vector 1101 will be larger than the resultant scaler value for the vector dot product of the product 2 vector 1203 with the partiality vector 1101. Accordingly, when using vector angles to impart this magnitude information, the vector dot product operation provides a simple and convenient way to determine proximity between a particular partiality and the performance/properties of a particular product to thereby greatly facilitate identifying a best product amongst a plurality of candidate products.

By way of further illustration, consider an example where a particular consumer as a strong partiality for organic produce and is financially able to afford to pay to observe that partiality. A dot product result for that person with respect to a product characterization vector(s) for organic apples that represent a cost of $10 on a weekly basis (i.e., Cv·P1v) might equal (1,1), hence yielding a scalar result of ∥1∥ (where Cv refers to the corresponding partiality vector for this person and P1v represents the corresponding product characterization vector for these organic apples). Conversely, a dot product result for this same person with respect to a product characterization vector(s) for non-organic apples that represent a cost of $5 on a weekly basis (i.e., Cv·P2v) might instead equal (1,0), hence yielding a scalar result of ∥½∥. Accordingly, although the organic apples cost more than the non-organic apples, the dot product result for the organic apples exceeds the dot product result for the non-organic apples and therefore identifies the more expensive organic apples as being the best choice for this person.

To continue with the foregoing example, consider now what happens when this person subsequently experiences some financial misfortune (for example, they lose their job and have not yet found substitute employment). Such an event can present the “force” necessary to alter the previously-established “inertia” of this person's steady-state partialities; in particular, these negatively-changed financial circumstances (in this example) alter this person's budget sensitivities (though not, of course their partiality for organic produce as compared to non-organic produce). The scalar result of the dot product for the $5/week non-organic apples may remain the same (i.e., in this example, ∥½∥), but the dot product for the $10/week organic apples may now drop (for example, to ∥½∥ as well). Dropping the quantity of organic apples purchased, however, to reflect the tightened financial circumstances for this person may yield a better dot product result. For example, purchasing only $5 (per week) of organic apples may produce a dot product result of ∥1∥. The best result for this person, then, under these circumstances, is a lesser quantity of organic apples rather than a larger quantity of non-organic apples.

In a typical application setting, it is possible that this person's loss of employment is not, in fact, known to the system. Instead, however, this person's change of behavior (i.e., reducing the quantity of the organic apples that are purchased each week) might well be tracked and processed to adjust one or more partialities (either through an addition or deletion of one or more partialities and/or by adjusting the corresponding partiality magnitude) to thereby yield this new result as a preferred result.

The foregoing simple examples clearly illustrate that vector dot product approaches can be a simple yet powerful way to quickly eliminate some product options while simultaneously quickly highlighting one or more product options as being especially suitable for a given person.

Such vector dot product calculations and results, in turn, help illustrate another point as well. As noted above, sine waves can serve as a potentially useful way to characterize and view partiality information for both people and products/services. In those regards, it is worth noting that a vector dot product result can be a positive, zero, or even negative value. That, in turn, suggests representing a particular solution as a normalization of the dot product value relative to the maximum possible value of the dot product. Approached this way, the maximum amplitude of a particular sine wave will typically represent a best solution.

Taking this approach further, by one approach the frequency (or, if desired, phase) of the sine wave solution can provide an indication of the sensitivity of the person to product choices (for example, a higher frequency can indicate a relatively highly reactive sensitivity while a lower frequency can indicate the opposite). A highly sensitive person is likely to be less receptive to solutions that are less than fully optimum and hence can help to narrow the field of candidate products while, conversely, a less sensitive person is likely to be more receptive to solutions that are less than fully optimum and can help to expand the field of candidate products.

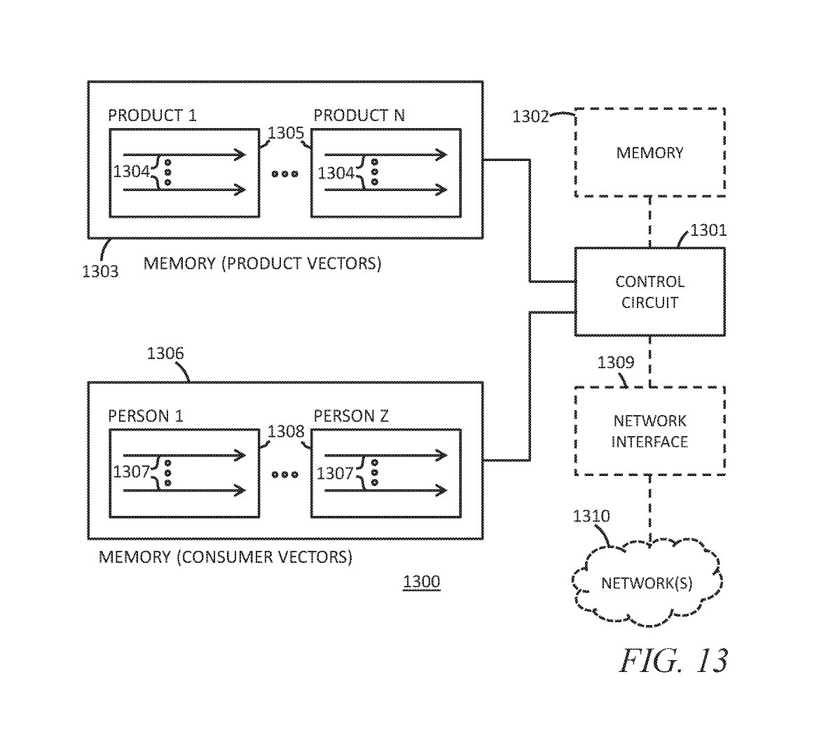

FIG. 13 presents an illustrative apparatus 1300 for conducting, containing, and utilizing the foregoing content and capabilities. In this particular example, the enabling apparatus 1300 includes a control circuit 1301. Being a “circuit,” the control circuit 1301 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 1301 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 1301 is configured (for example, by using corresponding programming as will be well understood by those skilled in the art) to carry out one or more of the steps, actions, and/or functions described herein.

By one optional approach the control circuit 1301 operably couples to a memory 1302. This memory 1302 may be integral to the control circuit 1301 or can be physically discrete (in whole or in part) from the control circuit 1301 as desired. This memory 1302 can also be local with respect to the control circuit 1301 (where, for example, both share a common circuit board, chassis, power supply, and/or housing) or can be partially or wholly remote with respect to the control circuit 1301 (where, for example, the memory 1302 is physically located in another facility, metropolitan area, or even country as compared to the control circuit 1301).

This memory 1302 can serve, for example, to non-transitorily store the computer instructions that, when executed by the control circuit 1301, cause the control circuit 1301 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

Either stored in this memory 1302 or, as illustrated, in a separate memory 1303 are the vectorized characterizations 1304 for each of a plurality of products 1305 (represented here by a first product through an Nth product where “N” is an integer greater than “1”). In addition, and again either stored in this memory 1302 or, as illustrated, in a separate memory 1306 are the vectorized characterizations 1307 for each of a plurality of individual persons 1308 (represented here by a first person through a Zth person wherein “Z” is also an integer greater than “1”).

In this example the control circuit 1301 also operably couples to a network interface 1309. So configured the control circuit 1301 can communicate with other elements (both within the apparatus 1300 and external thereto) via the network interface 1309. Network interfaces, including both wireless and non-wireless platforms, are well understood in the art and require no particular elaboration here. This network interface 1309 can compatibly communicate via whatever network or networks 1310 may be appropriate to suit the particular needs of a given application setting. Both communication networks and network interfaces are well understood areas of prior art endeavor and therefore no further elaboration will be provided here in those regards for the sake of brevity.

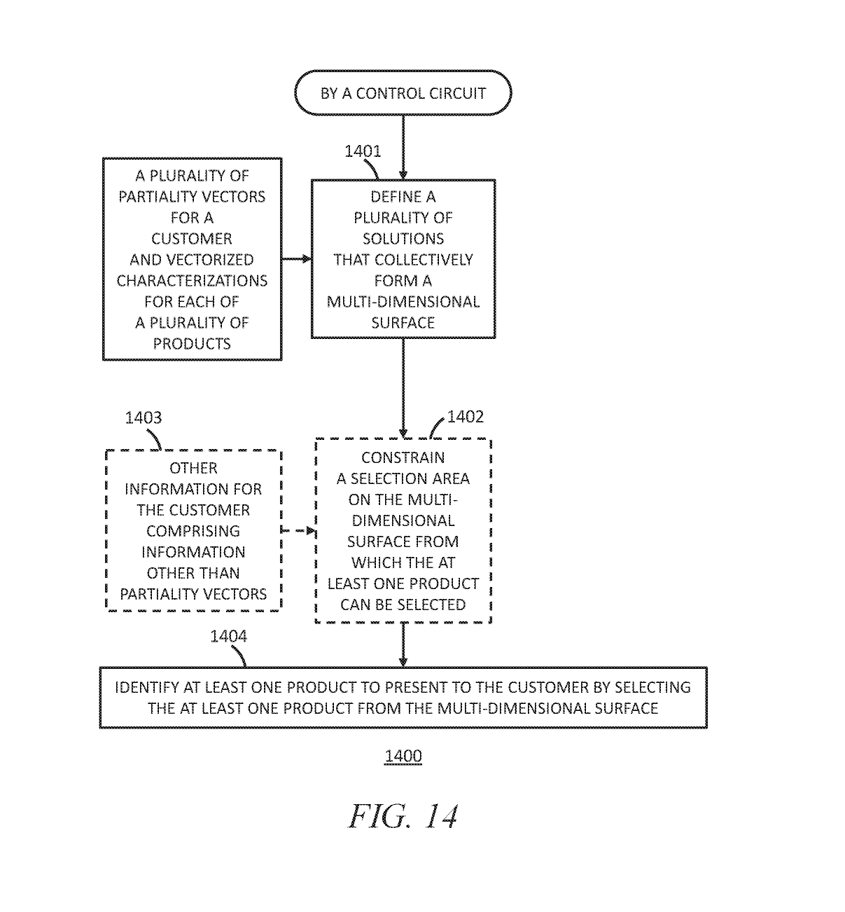

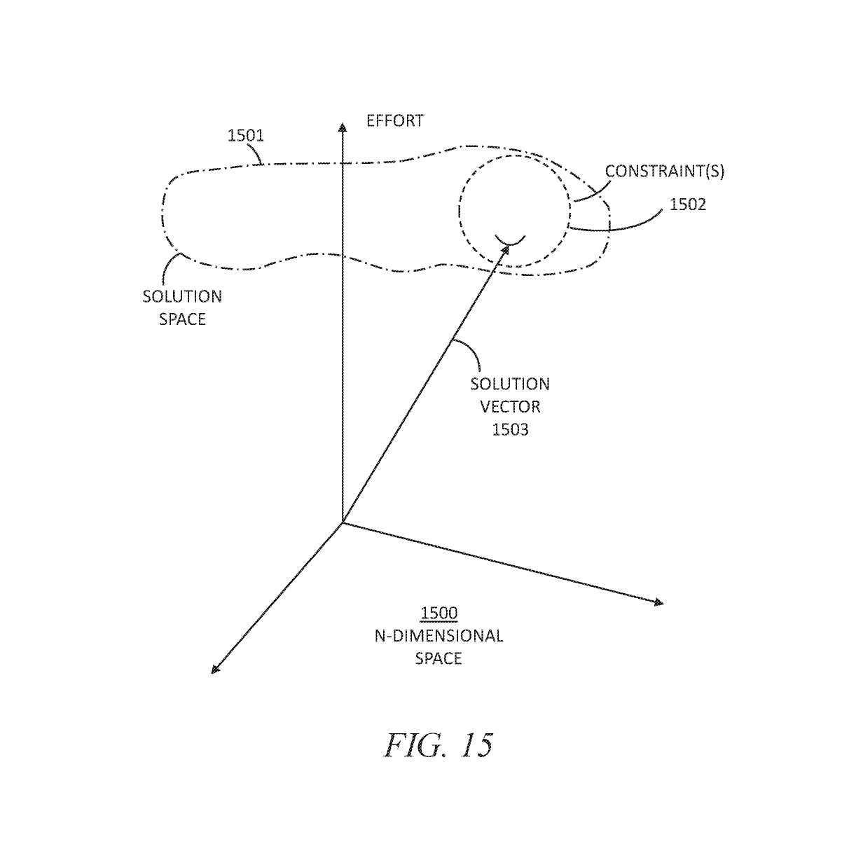

By one approach, and referring now to FIG. 14, the control circuit 1301 is configured to use the aforementioned partiality vectors 1307 and the vectorized product characterizations 1304 to define a plurality of solutions that collectively form a multidimensional surface (per block 1401). FIG. 15 provides an illustrative example in these regards. FIG. 15 represents an N-dimensional space 1500 and where the aforementioned information for a particular customer yielded a multi-dimensional surface denoted by reference numeral 1501. (The relevant value space is an N-dimensional space where the belief in the value of a particular ordering of one's life only acts on value propositions in that space as a function of a least-effort functional relationship.)

Generally speaking, this surface 1501 represents all possible solutions based upon the foregoing information. Accordingly, in a typical application setting this surface 1501 will contain/represent a plurality of discrete solutions. That said, and also in a typical application setting, not all of those solutions will be similarly preferable. Instead, one or more of those solutions may be particularly useful/appropriate at a given time, in a given place, for a given customer.

With continued reference to FIGS. 14 and 15, at optional block 1402 the control circuit 1301 can be configured to use information for the customer 1403 (other than the aforementioned partiality vectors 1307) to constrain a selection area 1502 on the multi-dimensional surface 1501 from which at least one product can be selected for this particular customer. By one approach, for example, the constraints can be selected such that the resultant selection area 1502 represents the best 95th percentile of the solution space. Other target sizes for the selection area 1502 are of course possible and may be useful in a given application setting.

The aforementioned other information 1403 can comprise any of a variety of information types. By one approach, for example, this other information comprises objective information. (As used herein, “objective information” will be understood to constitute information that is not influenced by personal feelings or opinions and hence constitutes unbiased, neutral facts.)

One particularly useful category of objective information comprises objective information regarding the customer. Examples in these regards include, but are not limited to, location information regarding a past, present, or planned/scheduled future location of the customer, budget information for the customer or regarding which the customer must strive to adhere (such that, by way of example, a particular product/solution area may align extremely well with the customer's partialities but is well beyond that which the customer can afford and hence can be reasonably excluded from the selection area 1502), age information for the customer, and gender information for the customer. Another example in these regards is information comprising objective logistical information regarding providing particular products to the customer. Examples in these regards include but are not limited to current or predicted product availability, shipping limitations (such as restrictions or other conditions that pertain to shipping a particular product to this particular customer at a particular location), and other applicable legal limitations (pertaining, for example, to the legality of a customer possessing or using a particular product at a particular location).

At block 1404 the control circuit 1301 can then identify at least one product to present to the customer by selecting that product from the multi-dimensional surface 1501. In the example of FIG. 15, where constraints have been used to define a reduced selection area 1502, the control circuit 1301 is constrained to select that product from within that selection area 1502. For example, and in accordance with the description provided herein, the control circuit 1301 can select that product via solution vector 1503 by identifying a particular product that requires a minimal expenditure of customer effort while also remaining compliant with one or more of the applied objective constraints based, for example, upon objective information regarding the customer and/or objective logistical information regarding providing particular products to the customer.

So configured, and as a simple example, the control circuit 1301 may respond per these teachings to learning that the customer is planning a party that will include seven other invited individuals. The control circuit 1301 may therefore be looking to identify one or more particular beverages to present to the customer for consideration in those regards. The aforementioned partiality vectors 1307 and vectorized product characterizations 1304 can serve to define a corresponding multi-dimensional surface 1501 that identifies various beverages that might be suitable to consider in these regards.

Objective information regarding the customer and/or the other invited persons, however, might indicate that all or most of the participants are not of legal drinking age. In that case, that objective information may be utilized to constrain the available selection area 1502 to beverages that contain no alcohol. As another example in these regards, the control circuit 1301 may have objective information that the party is to be held in a state park that prohibits alcohol and may therefore similarly constrain the available selection area 1502 to beverages that contain no alcohol.

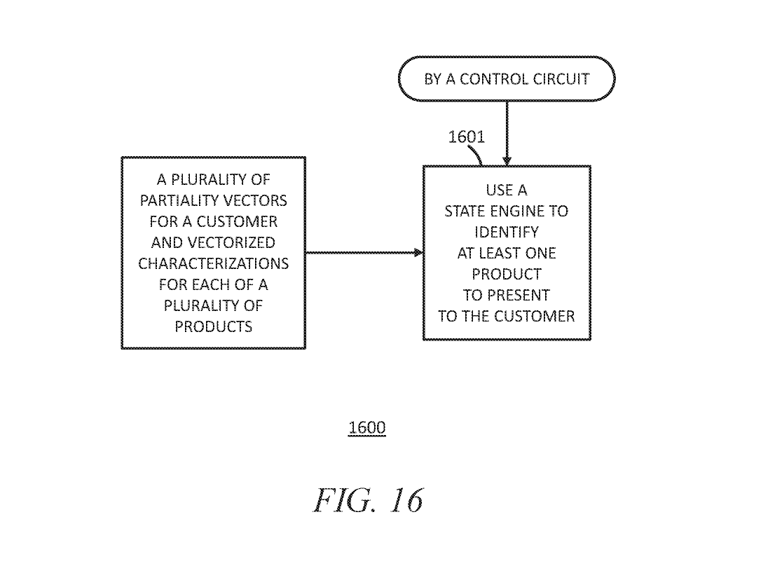

As described above, the aforementioned control circuit 1301 can utilize information including a plurality of partiality vectors for a particular customer along with vectorized product characterizations for each of a plurality of products to identify at least one product to present to a customer. By one approach 1600, and referring to FIG. 16, the control circuit 1301 can be configured as (or to use) a state engine to identify such a product (as indicated at block 1601). As used herein, the expression “state engine” will be understood to refer to a finite-state machine, also sometimes known as a finite-state automaton or simply as a state machine.

Generally speaking, a state engine is a basic approach to designing both computer programs and sequential logic circuits. A state engine has only a finite number of states and can only be in one state at a time. A state engine can change from one state to another when initiated by a triggering event or condition often referred to as a transition. Accordingly, a particular state engine is defined by a list of its states, its initial state, and the triggering condition for each transition.

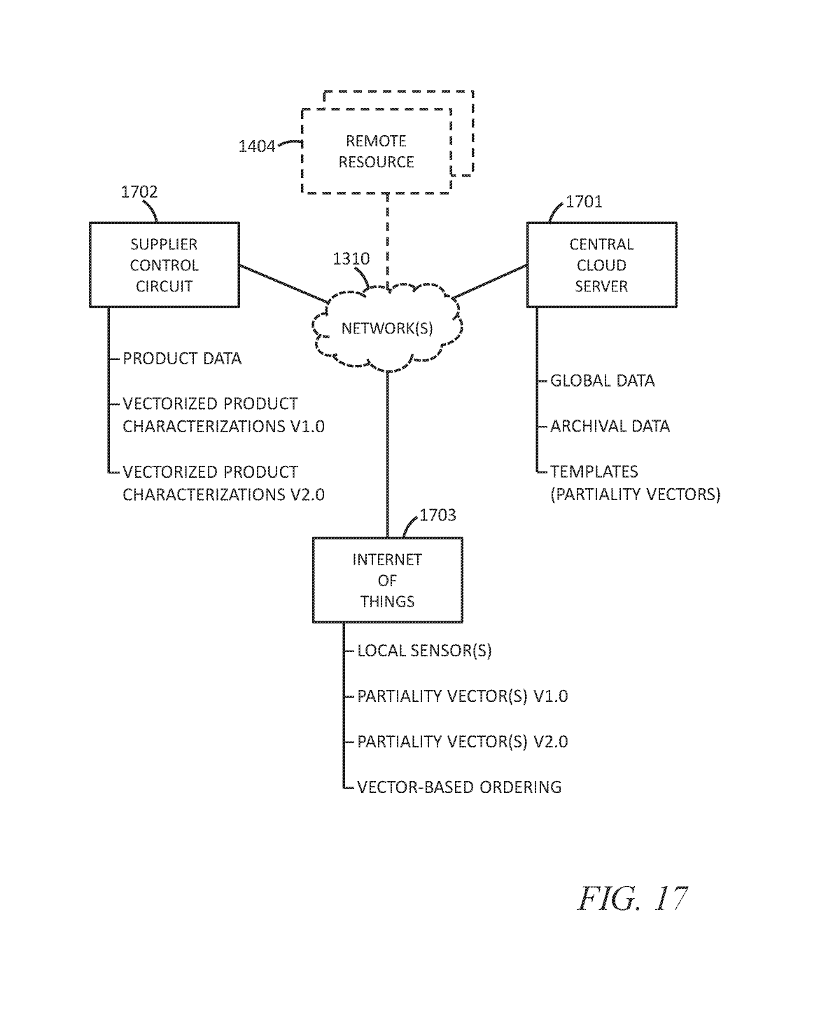

It will be appreciated that the apparatus 1300 described above can be viewed as a literal physical architecture or, if desired, as a logical construct. For example, these teachings can be enabled and operated in a highly centralized manner (as might be suggested when viewing that apparatus 1300 as a physical construct) or, conversely, can be enabled and operated in a highly decentralized manner. FIG. 17 provides an example as regards the latter.

In this illustrative example a central cloud server 1701, a supplier control circuit 1702, and the aforementioned Internet of Things 1703 communicate via the aforementioned network 1310.

The central cloud server 1701 can receive, store, and/or provide various kinds of global data (including, for example, general demographic information regarding people and places, profile information for individuals, product descriptions and reviews, and so forth), various kinds of archival data (including, for example, historical information regarding the aforementioned demographic and profile information and/or product descriptions and reviews), and partiality vector templates as described herein that can serve as starting point general characterizations for particular individuals as regards their partialities. Such information may constitute a public resource and/or a privately-curated and accessed resource as desired. (It will also be understood that there may be more than one such central cloud server 1701 that store identical, overlapping, or wholly distinct content.)

The supplier control circuit 1702 can comprise a resource that is owned and/or operated on behalf of the suppliers of one or more products (including but not limited to manufacturers, wholesalers, retailers, and even resellers of previously-owned products). This resource can receive, process and/or analyze, store, and/or provide various kinds of information. Examples include but are not limited to product data such as marketing and packaging content (including textual materials, still images, and audio-video content), operators and installers manuals, recall information, professional and non-professional reviews, and so forth.

Another example comprises vectorized product characterizations as described herein. More particularly, the stored and/or available information can include both prior vectorized product characterizations (denoted in FIG. 17 by the expression “vectorized product characterizations V1.0”) for a given product as well as subsequent, updated vectorized product characterizations (denoted in FIG. 17 by the expression “vectorized product characterizations V2.0”) for the same product. Such modifications may have been made by the supplier control circuit 1702 itself or may have been made in conjunction with or wholly by an external resource as desired.

The Internet of Things 1703 can comprise any of a variety of devices and components that may include local sensors that can provide information regarding a corresponding user's circumstances, behaviors, and reactions back to, for example, the aforementioned central cloud server 1701 and the supplier control circuit 1702 to facilitate the development of corresponding partiality vectors for that corresponding user. Again, however, these teachings will also support a decentralized approach. In many cases devices that are fairly considered to be members of the Internet of Things 1703 constitute network edge elements (i.e., network elements deployed at the edge of a network). In some case the network edge element is configured to be personally carried by the person when operating in a deployed state. Examples include but are not limited to so-called smart phones, smart watches, fitness monitors that are worn on the body, and so forth. In other cases, the network edge element may be configured to not be personally carried by the person when operating in a deployed state. This can occur when, for example, the network edge element is too large and/or too heavy to be reasonably carried by an ordinary average person. This can also occur when, for example, the network edge element has operating requirements ill-suited to the mobile environment that typifies the average person.

For example, a so-called smart phone can itself include a suite of partiality vectors for a corresponding user (i.e., a person that is associated with the smart phone which itself serves as a network edge element) and employ those partiality vectors to facilitate vector-based ordering (either automated or to supplement the ordering being undertaken by the user) as is otherwise described herein. In that case, the smart phone can obtain corresponding vectorized product characterizations from a remote resource such as, for example, the aforementioned supplier control circuit 1702 and use that information in conjunction with local partiality vector information to facilitate the vector-based ordering.

Also, if desired, the smart phone in this example can itself modify and update partiality vectors for the corresponding user. To illustrate this idea in FIG. 17, this device can utilize, for example, information gained at least in part from local sensors to update a locally-stored partiality vector (represented in FIG. 17 by the expression “partiality vector V1.0”) to obtain an updated locally-stored partiality vector (represented in FIG. 17 by the expression “partiality vector V2.0”). Using this approach, a user's partiality vectors can be locally stored and utilized. Such an approach may better comport with a particular user's privacy concerns.

It will be understood that the smart phone employed in the immediate example is intended to serve in an illustrative capacity and is not intended to suggest any particular limitations in these regards. In fact, any of a wide variety of Internet of Things devices/components could be readily configured in the same regards. As one simple example in these regards, a computationally-capable networked refrigerator could be configured to order appropriate perishable items for a corresponding user as a function of that user's partialities.

Presuming a decentralized approach, these teachings will accommodate any of a variety of other remote resources 1704. These remote resources 1704 can, in turn, provide static or dynamic information and/or interaction opportunities or analytical capabilities that can be called upon by any of the above-described network elements. Examples include but are not limited to voice recognition, pattern and image recognition, facial recognition, statistical analysis, computational resources, encryption and decryption services, fraud and misrepresentation detection and prevention services, digital currency support, and so forth.

As already suggested above, these approaches provide powerful ways for identifying products and/or services that a given person, or a given group of persons, may likely wish to buy to the exclusion of other options. When the magnitude and direction of the relevant/required meta-force vector that comes from the perceived effort to impose order is known, these teachings will facilitate, for example, engineering a product or service containing potential energy in the precise ordering direction to provide a total reduction of effort. Since people generally take the path of least effort (consistent with their partialities) they will typically accept such a solution.

As one simple illustrative example, a person who exhibits a partiality for food products that emphasize health, natural ingredients, and a concern to minimize sugars and fats may be presumed to have a similar partiality for pet foods because such partialities may be based on a value system that extends beyond themselves to other living creatures within their sphere of concern. If other data is available to indicate that this person in fact has, for example, two pet dogs, these partialities can be used to identify dog food products having well-aligned vectors in these same regards. This person could then be solicited to purchase such dog food products using any of a variety of solicitation approaches (including but not limited to general informational advertisements, discount coupons or rebate offers, sales calls, free samples, and so forth).

As another simple example, the approaches described herein can be used to filter out products/services that are not likely to accord well with a given person's partiality vectors. In particular, rather than emphasizing one particular product over another, a given person can be presented with a group of products that are available to purchase where all of the vectors for the presented products align to at least some predetermined degree of alignment/accord and where products that do not meet this criterion are simply not presented.

And as yet another simple example, a particular person may have a strong partiality towards both cleanliness and orderliness. The strength of this partiality might be measured in part, for example, by the physical effort they exert by consistently and promptly cleaning their kitchen following meal preparation activities. If this person were looking for lawn care services, their partiality vector(s) in these regards could be used to identify lawn care services who make representations and/or who have a trustworthy reputation or record for doing a good job of cleaning up the debris that results when mowing a lawn. This person, in turn, will likely appreciate the reduced effort on their part required to locate such a service that can meaningfully contribute to their desired order.

These teachings can be leveraged in any number of other useful ways. As one example in these regards, various sensors and other inputs can serve to provide automatic updates regarding the events of a given person's day. By one approach, at least some of this information can serve to help inform the development of the aforementioned partiality vectors for such a person. At the same time, such information can help to build a view of a normal day for this particular person. That baseline information can then help detect when this person's day is going experientially awry (i.e., when their desired “order” is off track). Upon detecting such circumstances these teachings will accommodate employing the partiality and product vectors for such a person to help make suggestions (for example, for particular products or services) to help correct the day's order and/or to even effect automatically-engaged actions to correct the person's experienced order.

When this person's partiality (or relevant partialities) are based upon a particular aspiration, restoring (or otherwise contributing to) order to their situation could include, for example, identifying the order that would be needed for this person to achieve that aspiration. Upon detecting, (for example, based upon purchases, social media, or other relevant inputs) that this person is aspirating to be a gourmet chef, these teachings can provide for plotting a solution that would begin providing/offering additional products/services that would help this person move along a path of increasing how they order their lives towards being a gourmet chef.

By one approach, these teachings will accommodate presenting the consumer with choices that correspond to solutions that are intended and serve to test the true conviction of the consumer as to a particular aspiration. The reaction of the consumer to such test solutions can then further inform the system as to the confidence level that this consumer holds a particular aspiration with some genuine conviction. In particular, and as one example, that confidence can in turn influence the degree and/or direction of the consumer value vector(s) in the direction of that confirmed aspiration.

All the above approaches are informed by the constraints the value space places on individuals so that they follow the path of least perceived effort to order their lives to accord with their values which results in partialities. People generally order their lives consistently unless and until their belief system is acted upon by the force of a new trusted value proposition. The present teachings are uniquely able to identify, quantify, and leverage the many aspects that collectively inform and define such belief systems.

A person's preferences can emerge from a perception that a product or service removes effort to order their lives according to their values. The present teachings acknowledge and even leverage that it is possible to have a preference for a product or service that a person has never heard of before in that, as soon as the person perceives how it will make their lives easier they will prefer it. Most predictive analytics that use preferences are trying to predict a decision the customer is likely to make. The present teachings are directed to calculating a reduced effort solution that can/will inherently and innately be something to which the person is partial.

Generally speaking, pursuant to various embodiments, systems, apparatuses and methods are provided herein for mobile manufacturing. In some embodiments, a system for providing mobile manufacturing comprises a customer profile database storing customer profiles for a plurality of customers, product database, a mobile manufacturing unit comprising a vehicle carrying mobile manufacturing equipment, and a control circuit coupled to the customer profile database, the product database, and the mobile manufacturing unit. The control circuit being configured to: determine area customer partialities for a geographic area based on the customer profile database, determine an estimated demand based on the area customer partialities and the product database, select a plurality of manufacturing materials for the geographic area based on the estimated demand, and cause the plurality of manufacturing materials to be loaded onto the mobile manufacturing unit.

In some embodiments, a system for providing mobile manufacturing comprises a customer profile database storing customer partiality vectors associated with a plurality of customers, a product database storing vectorized product characterizations associated with a plurality of products, a mobile manufacturing unit comprising a vehicle carrying manufacturing equipment; and a control circuit coupled to the customer profile database, the product database, and the mobile manufacturing unit. The control circuit being configured to select a plurality of customer profiles associated with a geographic area from the customer profile database, aggregate a plurality of customer partiality vectors associated with the plurality of customers to determine aggregated area customer partiality vectors, determine alignments between the aggregated area customer partiality vectors and vectorized product characterizations associated with the plurality of products stored in the product database, select one or more products to manufacture with the mobile manufacturing unit stationed in the geographic area based on the alignments, and instruct the mobile manufacturing unit to begin manufacturing the one or more products prior to receiving orders for the one or more products.

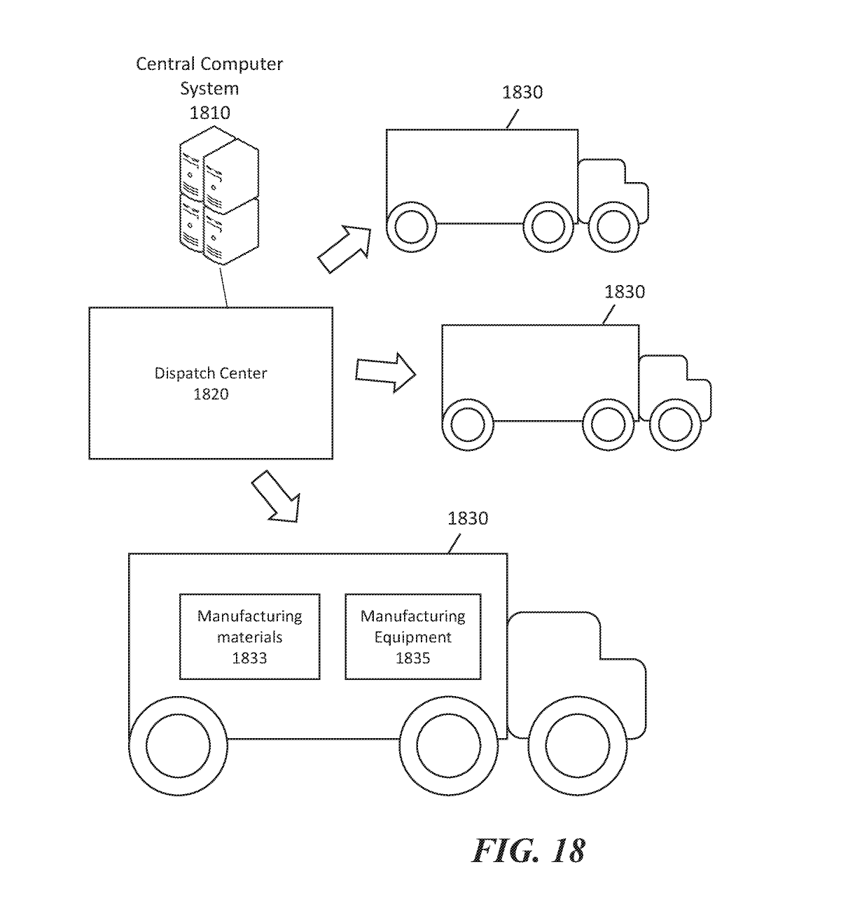

Referring first to FIG. 18, a system for providing mobile manufacturing is shown. The system comprises a central computer system 1810, a dispatch center 1820, and a plurality of mobile manufacturing units (MMU) 1830.

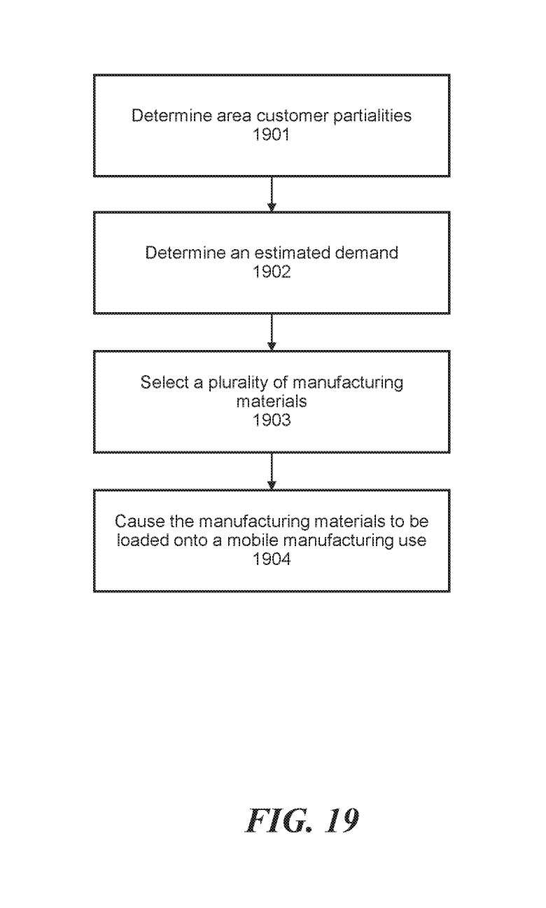

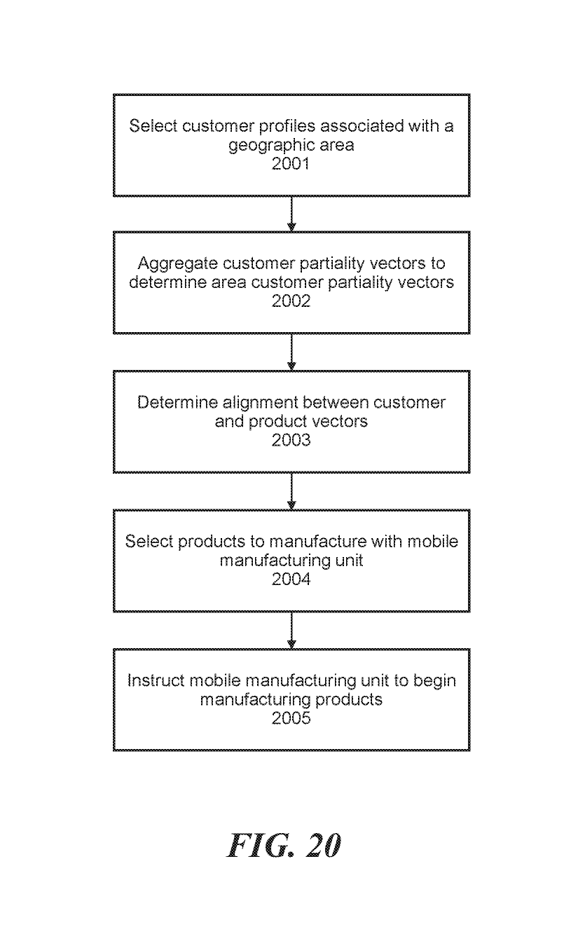

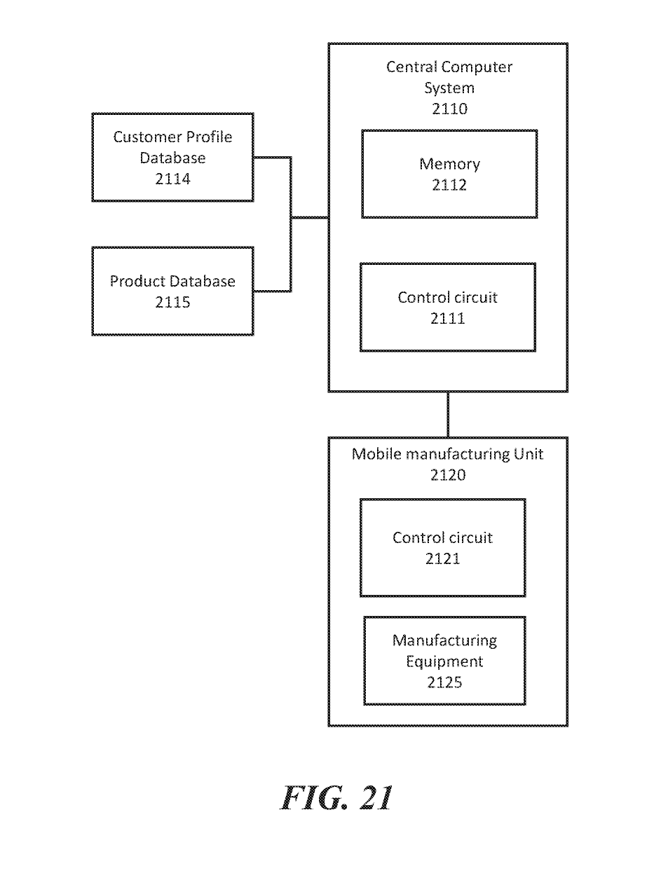

The central computer system 1810 may comprise a control circuit, a central processing unit, a processor, a microprocessor and the like and may be one or more of a server, a central computing system, a cloud-based server, a personal computer system and the like. Generally, the central computer system 1810 may comprise any processor-based device configured to provide instructions to one or more dispatch centers 1820 and/or MMUs 1830. The central computer system 1810 may include a processor configured to execute computer readable instructions stored on a computer readable storage memory. In some embodiments, the central computer system 1810 may be configured to use area customer information to select manufacturing materials to load onto MMUs 1830 for dispatch to different geographic areas. In some embodiments, the central computer system 1810 may be configured to use area customer information to instruct MMUs 1830 to predictively manufacture products before products are ordered by a customer. In some embodiments, the central computer system 1810 may be configured to communicate with the dispatch center 1820 and/or the MMU 1830 via one or more of a wireless data connection, a wired data connection, a local network, a mobile data network, a satellite data network, a Wi-Fi network, a cellular network, the Internet, and the like. In some embodiments, the central computer system 1810 may perform one or more steps described with reference to FIGS. 19 and 20 herein. Further details of a central computer system 1810 according to some embodiments is provided with reference to FIG. 21 herein.

The dispatch center 1820 may generally comprise a facility from which MMUs are dispatched. In some embodiments, the dispatch center 1820 may comprise a distribution center, a warehouse, a storage facility, a store, an MMU service station, etc. In some embodiments, the dispatch center 1820 may be configured to restock, reconfigure, and/or service MMUs. In some embodiments, MMUs 1830 may be restocked with other transport vehicles. In some embodiments, the dispatch center 1820 may itself comprise a mobile unit configured to supply and service dispatched MMUs 1830. While one dispatch center 1820 is shown in FIG. 18, the system may comprise a network of a plurality of geographically dispersed dispatch centers. In some embodiments, an MMU 1830 may be assigned to a dispatch center 1820 and/or may use different dispatch centers based the locations of one or more of the MMU 1830, the assigned geographic area, selected manufacturing materials 1833, and selected manufacturing equipment 1835 needed.

In some embodiments, the dispatch center 1820 may store a plurality of types of manufacturing materials 1833 that may be selectively loaded onto MMUs 1830. In some embodiments, manufacturing materials 1833 may refer to material that are further processed before being sold to the customer. In some embodiments, manufacturing materials 1833 may comprise one or more of: 3D printing powder, 3D printing filament, decorative elements (e.g. apparel add-on, decorative decal, embossing thread, printer ink, etc.), base items configured to be modified (e.g. plain t-shirt, plain mailbox, blank card stock, plain cell phone case, etc.), alteration materials (e.g. tailoring thread, trimmer), parts of an item (e.g. furniture parts, machine parts, toy parts, etc.), live plants to be harvested on the MMU (e.g. tomato plant, mushroom farm, herbs, etc.), etc. In some embodiments, manufacturing materials 1833 may comprise any unfinished and/or semi-finished items that may be manufactured into goods for sale. In some embodiments, at least some manufacturing materials 1833 may comprise materials that requires further manufacturing prior to being sold to an end-user customer. In some embodiments, at least some manufacturing materials 1833 may be sold as-is (e.g. white t-shirt, unhemmed pants), but may also further be modified and/or customized before being sold.

In some embodiments, the dispatch center 1820 may further store a plurality of types of manufacturing equipment pieces that may be selectively loaded onto MMUs 1830. In some embodiments, manufacturing equipment 1835 may comprise equipment pieces for turning manufacturing materials 1833 into products for sale. In some embodiments, manufacturing equipment 1835 may comprise one or more of a 3D printer, a printer, a laser cutter, a screen printer, a decal applicator, a sewing machine, etc. In some embodiments, the manufacturing equipment 1835 may comprise automated machinery that may be controlled by a computer onboard an MMU 1830 and/or the central computer system 1810. For example, the central computer system 1810 may send a 3D model to a 3D printer on the MMU 1830 and the 3D printer may be configured to automatically produce the 3D item based on the 3D model without human input at the MMU 1830. In some embodiments, the manufacturing equipment 1835 may comprise semi-automatic machinery configured to finish products for sale. For example, an associated may load a t-shirt into a screen printer and the screen printer may be configured to print an image to finish the t-shirt. In some embodiments, the manufacturing equipment 1835 may comprise manually operated equipment. For example, an associate may be instructed to assemble a delivery receiving box with tools on the MMU 1830 for a customer purchase.

The MMUs 1830 may comprise a vehicle carrying manufacturing materials 1833 and manufacturing equipment 1835. In some embodiments, an MMU 1830 may be configured to travel to a location to provide on-site product manufacturing for customer purchase. For example, when a customer orders a customized items, an MMU 1830 located near the customer may begin to manufacture the item and have the item ready for customer pickup by the time the customer arrives at the MMU 1830. With on-site mobile manufacturing, the turnaround time of custom items may be considerably reduced by reducing the shipping time after the product is made. In some embodiments, the MMUs 1830 may be dispatched to different neighborhoods to perform manufacturing for customers in different geographic areas. In some embodiments, an MMU 1830 may comprise a motored vehicle such as one or more of a truck, a van, a truck and trailer, and the like. Generally, the MMU 1830 may comprise any vehicle with sufficient capacity to carry the selected manufacturing materials 1833 and manufacturing equipment 1835. In some embodiments, the MMU 1830 may comprise a manned vehicle with a driver or unmanned vehicle such as an unmanned ground vehicle (UGV). In some embodiments, the MMU 1830 may comprise a communication device configured to communication with the central computer system 1810 while dispatched. In some embodiments, the communication device may comprise a wireless communication transceiver such as a mobile data network transceiver, a cellular transceiver, a Wi-Fi transceiver, a satellite transceiver, and the like. In some embodiments, the MMU 1830 may comprise a control circuit configured to receive instructions from and/or provide updates to the central computer system 1810. In some embodiments, the control circuit may be further configured to provide instructions to the manufacturing equipment 1835 onboard the MMU 1830. In some embodiments, the MMU 1830 may comprise other components typical of a vehicle such as vehicle controls, wheels, an engine, a power source (e.g. fuel tank, battery, etc.), navigation system, user interface devices, etc.

While the central computer system 1810 is shown outside of the dispatch center 1820 in FIG. 18, in some embodiments, the central computer system 1810 may be implemented at least partially in the dispatch center 1820 and/or on one or more of the MMUs 1830. In some embodiments, the central computer system 1810 may management and provide instructions to a plurality of dispatch centers. While one dispatch center 1820 and three MMUs 1830 are shown, the system may comprise any number of dispatch centers and MMUs serving one or more geographical areas of any size.

Referring next to FIG. 19, a method for providing mobile manufacturing according to some embodiments is shown. The steps in FIG. 19 may generally be performed by a processor-based device such as a central computer system, a server, a cloud-based server, a distribution management system, a dispatch center management system, an MMU management system, etc. In some embodiments, the steps in FIG. 19 may be performed by one or more of the central computer system 1810 described with reference to FIG. 18, control circuit 2111, and/or the control circuit 2121 described with reference to FIG. 21 herein.

In step 1901, the system determines area customer partialities for a geographic area. In some embodiments, the area customer partialities for the geographic area may be determined based on customer profiles for a plurality of customers stored in a customer profile database. In some embodiments, the customer profiles may comprise customer partiality vectors associated with the plurality of customers, the customer partiality vectors each represents at least one of a person's values, preferences, affinities, and aspirations. In some embodiments, the system may be configured to determine the area customer partialities for the geographic area based on aggregating a plurality of customer profiles selected based on customer locations associated with each of the plurality of customer profiles. In some embodiments, a geographic area may correspond to one or more of zip code(s), neighborhood(s), city(s), county(s), radius from an address, etc. In some embodiments, the customer profile database may store a plurality of customer profiles associated with existing and/or potential customers. In some embodiments, a customer profile may be associated with an individual customer or a collective of customers (e.g. household, office, etc.). In some embodiments, one or more locations/geographic areas may be associated with each customer profile. The geographic area associated with a customer profile may comprise one or more of the customer's residence location, work location, visited store(s), frequented store(s), etc. The customer profiles may be selected in step 1901 based on matching the geographic location with the one or more locations associated with the customers. In some embodiments, each geographic area may correspond to the estimated customer base of an MMU located at a selected dispatch location. In some embodiments, customer profiles having an associated location that falls within the geographic area may be selected to determine the area customer partialities in step 1901. In some embodiments, one or more locations associated with a customer may be updated by the system when the customer moves and/or changes their shopping habits.

In some embodiments, customer profiles stored in the customer profile database may comprise partiality vectors associated each customer. A customer's partiality may comprise one or more of a person's values, preferences, affinities, and aspirations. A customer's partiality vectors may comprise one or more of value vectors, preference vectors, affinity vectors, and aspiration vectors. In some embodiments, customer partiality vectors may each comprises a magnitude that corresponds to the customer's belief in good that comes from an order associated with that partiality. In some embodiments, the customer partiality vectors may be determined and/or updated with a purchase and/or return history of associated with the customer. In some embodiments, the area customer partialities may be determined based on other factors such as area purchase history, area demographic, current season, current weather, upcoming holidays, upcoming events, schools in the area, sports teams associated with the area, etc.

In step 1902, the system determines an estimated demand for the geographic area. In some embodiments, the estimated demand may be determined based on the area customer partialities determined in step 1901 and product information in a product database. In some embodiments, the estimated demand may be determined based on demand associated with finished products and/or manufacturing materials. In some embodiments, the product database may store product characteristics associated with a plurality of products that can be made on an MMU and/or manufacturing materials for making such products. In some embodiments, the product characteristics may comprise vectorized product characteristics that comprise correlating vectors to at least some of the customer partiality vectors. In some embodiments, vectorized product characteristics associated with products may be provided by the supplier, manually entered, and/or determined based on product name or other identifiers, product packaging, product marking, product brand, advertisements of the product, and/or customer purchase history associated with the product. In some embodiments, the product characteristics may be associated with different manufacturing materials, such as a base product (e.g. blank t-shirt, white mug, etc.), raw material (e.g. 3D printing filament, fabric), a customization option (e.g. different t-shirt designs, decals), etc. and the estimated demands for different manufacturing materials may be individually determined. For example, if the area customer partialities indicates that the customers are partial to environmentally friendly products, the system may estimate a higher demand for “green” manufacturing materials (e.g. biodegradable 3D printing filament) as compared to the cheaper non-biodegradable alternative. In another example, the system may estimate a high demand for fan gear based on an upcoming sports game (e.g. Super Bowl, World Series, etc.), and estimate the demand for customization options based on the area customer's favored team indicated in the area customer partialities.

In some embodiments, the estimated demand may be determined based on the alignment between customer partialities and vectorized product characteristics of finished products and/or manufacturing materials. In some embodiments, the alignment between a product and the area customer may be determined by adding, subtracting, multiplying, and/or dividing the magnitudes of the corresponding vectors in the area customer partiality vectors and product characterization vectors. In some embodiments, alignment scores for each vector may be added and/or averaged to determine an overall alignment score for a product or a material. In some embodiments, the estimated demand may comprise a general level of demand such as low, moderate, and high. In some embodiments, the estimated demand may comprise a unit count for one or more products and/or manufacturing materials. In some embodiments, step 1902 may further be based on other MMUs or brick-and-motor stores in the area. For example, if the area customer demand could be filled by another MMU already dispatched to or near the area, the estimated demand associated with an MMU may be adjusted to account for the existing supply.

In step 1903, the system selects a plurality of manufacturing materials for the geographic area based on the estimated demand. In some embodiments, the system may determine quantities of each of the one or more manufacturing materials to be loaded onto the MMU based on the area customer partialities. In some embodiments, the manufacturing materials selected may comprise materials with the highest alignments to the area customer partiality vectors and/or materials associated with products with the highest alignments to the area customer partiality vectors. In some embodiments, items may be selected based on categories associated with the item and/or related manufacturing materials. In some embodiments, manufacturing materials may be selected as to meet the estimated demand for finished products. In some embodiments, the system may assign a default set of manufacturing material to one or more MMUs, and the estimated demand specific to a geographic area may be used to select additional items to be carried by an MMU being dispatch to that geographic area. For example, an MMU may carry a set number of plain t-shirts by default and the system may select the types of decals and/or printer ink to be carried by the MMU based on the estimated demand. In another example, three spools each of conventional and biodegradable 3D printing filaments be loaded on an MMU by default and the system may determine how many and what types of additional spools of 3D printing filaments to load onto an MMU based on the estimated demand. In some embodiments, the estimated demand may be used to select all manufacturing materials for an MMU. In some embodiments, ready-to-sell products may also be selected to be carried by an MMU based on the estimated demand.

In step 1904, the system causes the manufacturing materials to be loaded onto the MMU. In some embodiments, the instructions may comprise machine instructions for item transport devices and/or displayed instructions for workers to retrieve and load the selected manufacturing materials and/or equipment on the MMU.

In some embodiments, the system may further select one or more manufacturing equipment pieces for the geographic area based on the estimated demand, and cause the one or more manufacturing equipment pieces to be loaded onto the MMU. For example, if a high demand for 3D printed objects is determined for a geographic area, the system may cause one or more 3D printers to be loaded onto the MMU. In some embodiments, the system may select manufacturing equipment pieces based on the selected manufacturing materials and/or select manufacturing materials based on the selected manufacturing equipment pieces. In some embodiments, the system may select manufacturing materials and/or equipment to load onto the MMU based on the space and/or weight capacity of the MMU. In some embodiments, the system may select from a plurality of MMUs to carry the selected manufacturing material and/or equipment based on the MMUs' space and/or weight capacity. In some embodiments, one or more manufacturing equipment pieces may be installed on some MMUs, and the system may select MMUs to deploy to different geographic areas based on estimated demand associated the manufacturing equipment on the MMU.

In some embodiments, after step 1904, the system may instruct the MMU to travel to the geographic area. In some embodiments, the MMU may travel to the geographic area and park at one or more locations within or near the geographic area to provide on-site mobile manufacturing. In some embodiments, the system may further be configured to select a parking location for the MMU based on one or more of customer distribution, location availability, location accessibility, location safety, etc. In some embodiments, the system may cause the MMU to manufacture one or more products using one or more of the plurality of manufacturing materials based on an order received from a customer. In some embodiments, the system may provide a shopping interface to customers to purchase products via an MMU. In some embodiments, products may be presented in the shopping interface as finished products, customizable items, configurable items, and/or products made with customer provided design and/or specification. In some embodiments, the customer orders may comprise home delivery orders and/or pick-up orders that a customer can retrieve at the MMU and/or another location. In some embodiments, when the system receives an order for a product from a customer, the system may select one of a plurality of MMUs to manufacture the product based on locations of the plurality of MMUs and the customer. For example, when an order is received, the system may determine which MMUs in the area is carrying the needed manufacturing materials and equipment and assign the order to an MMU that is closest to the customer's delivery or pickup address. In some embodiments, the system may monitor the workload and processing define:queue at a plurality of MMUs and distribute manufacturing tasks based on the amount of unfished tasks at one or more equipment pieces on the MMUs. In some embodiments, customers may be presented a plurality of MMU locations and be prompted to select an MMU to manufacture their order. In some embodiments, the user interface may further provide the estimated turnaround time at each of the MMUs in the area for customer selection. In some embodiments, the system may provide text instructions to associates stationed at the MMU to use the manufacturing equipment to produce the ordered products. In some embodiments, the system may send machine instructions directly to manufacturing equipment to begin producing the ordered products.

In some embodiments, after step 1904, the system may predict one or more products likely to be ordered by customers in the geographic area based on the area customer partialities and the product database and cause the mobile manufacturing unit to begin manufacturing the one or more products prior to receiving an order for the one or more products. For example, if the system determines a very high demand for a t-shirt of a particular design, the system may cause the MMU to begin printing the selected design on t-shirts of different sizes before orders for such t-shirts are actually received. In some embodiments, the predictive mobile manufacturing may be performed based on one or more steps described with reference FIG. 20 herein.

In some embodiments, after step 1904, the system may select one or more additional manufacturing materials to replenish the MMU while the MMU is deployed. In some embodiments, the replenish materials may be selected based on one or more of: products manufactured by the mobile manufacturing unit, products ordered by customers in the geographic area, and a quantity of one or more of the plurality of manufacturing materials on the mobile manufacturing unit. In some embodiments, the replenish materials may be selected with a process similar to steps 1901-1903. The system may then cause a delivery vehicle to transport the one or more additional manufacturing materials to the MMU deployed to a geographic area to replenish the MMU.

In some embodiments, steps 1901 to 1904 may be repeated for different geographic areas and different MMUs. In some embodiments, the system may dispatch a plurality of MMUs carrying different type of manufacturing materials and/or equipment to the same area based on the estimated demand of the customers in the area. In some embodiments, an MMU may be instructed to return to the dispatch location periodically and/or when the manufacturing material runs low. In some embodiments, an MMU may remain in the same geographic area and serve the customers in that area for an extend period of time (e.g. days, weeks, months). In some embodiments, an MMU may be assigned to a new location without returning dispatch location. For example, an MMU configured to print game-day t-shirts may be dispatch to a football stadium a game day and then sent to a baseball field the next day with the remaining manufacturing materials onboard. In some embodiments, the system may monitor for the level of manufacturing materials and/or the condition of manufacturing equipment on board one or more MMUs in the system and determine whether to dispatch an MMU to another location, instruct the MMU to return to a dispatch location, and/or send a transport vehicle to replenish the MMU.

Referring next to FIG. 20, a method for providing mobile manufacturing according to some embodiments is shown. The steps in FIG. 20 may generally be performed by a processor-based device such as a central computer system, a server, a cloud-based server, a distribution management system, a dispatch center management system, an MMU management system, etc. In some embodiments, the steps in FIG. 20 may be performed by one or more of the central computer system 1810 described with reference to FIG. 18, control circuit 2111, and/or the control circuit 2121 described with reference to FIG. 21 herein.

In step 2001, the system selects customer profiles for a geographic area. The customer profiles may be selected from a customer profile database comprising a plurality of customer profiles associated with existing and/or potential customers. In some embodiments, a customer profile may be associated with an individual customer or a collective of customers (e.g. household, office, etc.). In some embodiments, one or more locations may be associated with each customer profile. The locations associated with a customer profile may comprise one or more of the customer's residence location, work location, visited store(s), frequented store(s), etc. The customer profiles may be selected in step 2001 based on matching the geographic area with the one or more locations associated with the customers. In some embodiments, a geographic area may correspond to one or more of zip code(s), neighborhood(s), city(s), county(s), radius from an address, etc. In some embodiments, customer profiles having an associated location that falls within the geographic area comprising the estimated customer base of the geographic area may be selected in step 2001. In some embodiments, one or more locations associated with a customer may be updated by the system when the customer moves and/or changes their shopping habits.

Customer profiles stored in the customer profile database may further comprise partiality vectors associated each customer. A customer's partialities may comprise one or more of a person's values, preferences, affinities, and aspirations. A customer's partiality vectors may comprise one or more of value vectors, preference vectors, affinity vectors, and aspiration vectors. In some embodiments, customer partiality vectors may each comprises a magnitude that corresponds to the customer's belief in good that comes from an order associated with that partiality. In some embodiments, the customer partiality vectors, including value vectors, may be determined and/or updated with a purchase and/or return history of associated with the customer.

In step 2002, the system aggregates a plurality of customer partiality vectors. In some embodiments, the plurality of customer partiality vectors may be aggregated by combining magnitudes associated with each partiality vector. In some embodiments, the magnitudes of each partiality vector may be averaged to determine magnitudes of a plurality of area customer partiality vectors. In some embodiments, a distribution of magnitudes for each vector may be determined (e.g. 10% low, 50% medium, and 40% high). In some embodiments, the plurality of customer partiality vectors may be aggregated by clustering similar partiality vectors associated with a plurality of customer. In some embodiments, customer partiality vectors associated with different customers may be weighted differently to determine the area customer partiality vector. For example, the partiality vectors may be weighted based on one or more of: how often the customer makes purchases, how far the customer lives from the selected MMU dispatch location, and other customer demographic information. In some embodiments, in step 2002, the system may select a subset of prominent vectors such as vectors with a high percentage of high magnitudes among the customers in the geographic area. In some embodiments, customers with similar sets of partiality vectors may be grouped into customer categories (e.g. value shoppers, health conscious, etc.) in step 2002. The system may then aggregate the customer vectors by determining the proportional distribution of customers in each category in the area. The aggregated customer partiality vectors associated with a geographic area may be referred to as the area customer partiality vector. In some embodiments, the systems may aggregate one or more types of partiality vectors (e.g. value, preferences, affinities, and aspirations vectors) separately or in combination.

In step 2003, the system determines an alignment between the area customer vectors and different products. In some embodiments, the system determines the alignments between the aggregated area customer partiality vectors and vectorized product characterizations associated with one or more products stored in a product database. In some embodiments, the products may comprise products that may be manufactured with the manufacturing materials and equipment pieces onboard an MMU dispatched to the associated geographic location. In some embodiments, vectorized product characteristics associated with products may be provided by the supplier, manually entered, and/or determined based on product name or other identifiers, product packaging, product marking, product brand, advertisements of the product, and/or customer purchase history associated with the product. In some embodiments, the alignment between a product and the area customer may be determined by adding, subtracting, multiplying, and/or dividing the magnitudes of the corresponding vectors in the customer partiality vectors and product characterization vectors. In some embodiments, alignment scores for each vector may be added and/or averaged to determine an overall alignment score for a product. In some embodiments, the system may only consider the prominent vectors associated with the area customers in determining the alignment in step 2003. In some embodiments, alignments with products may be separately determined for different customer categories in step 2003.

In step 2004, the system selects one or more products to manufacture with the MMU. In some embodiments, the products selected may comprise items with the highest alignments to the area customer partiality vectors. In some embodiments, the selected products may be limited to products that can be manufactured by the manufacturing material and equipment onboard the MMU. In some embodiments, the system may instruct transport units to supply additional manufacturing materials and/or equipment to MMU to manufacture the selected products. In some embodiments, products may be selected based on categories associated with the item. For example, the system set a limit to the number of finished products or product types to be carried on the MMU at a time. In another example, the system may set a reserve amount of manufacturing material that would not be used to predictively manufacture products not yet ordered by customers. In some embodiments, the system may further consider other factors such as: area purchase history, area demographic, current season, current weather, upcoming holidays, and upcoming events, etc. in selecting products to predictively manufacture in step 2005. In some embodiments, the system may further be configured to select products based on products that customers placed into their virtual shopping carts but have not yet ordered.

In step 2005, the system instructs a deployed MMU to begin manufacturing the item. In some embodiments, the system may cause the MMU to manufacture one or more products selected in step 2004 using one or more of the plurality of manufacturing materials onboard the MMU. Generally, step 2005 occurs prior to an order for the selected items is received from a customer. In some embodiments, the system may provide text instructions to associates stationed at the MMU to use the manufacturing equipment to produce the selected products. In some embodiments, the system may send machine instructions directly to manufacturing equipment pieces to begin producing the selected products.

In some embodiments, products manufactured based on steps 2001-2005 may be held at the MMU and/or another storage location (e.g. store, warehouse store) until a customer orders a matching product. When a customer places an order for the product, the customer may pick up the manufactured product at the MMU or at another location, or have the product delivered to a customer designated location. In some embodiments, the finished product may be display at the MMU and/or a store location similar to a regular product-for-sale for customer selection and purchase.

In some embodiments, steps 2001-2005 may be periodically repeated. In some embodiments, the products selected in step 2004 may further be based on the sales history since the last product selection and/or the remaining amount of manufacturing materials onboard the MMU. In some embodiments, the customer profiles in the customer profile database may be updated based on detected changes in the customer's partialities, location information, and recent purchase history. For example, when a customer moves, the location(s) associated with the customer's profile may change and a customer previously selected in step 2001 for one geographic area may become part of the customer base of a different geographic area. The collection of customers profiles selected in step 2001 may then vary each time the steps are repeated resulting in different aggregated area customer partiality vectors and products to predictively manufacture. In some embodiments, if a new potential customer moves into an area associated with a geographic area and little or no customer partialities are known in the customer profile database, the system may associate a set of default partiality vectors with the new customer. In some embodiments, the set of default partiality vectors may be selected from several default partiality vectors based on the new customer's demographics information.

In some embodiments, the processes shown in FIGS. 19 and 20 may be carried out together. For example, estimated demand determined in step 1902 may correspond to or be based on the area customer partialities and/or the product alignment determined in step 2001-2003. In some embodiments, the estimated demand determined in step 1902 may be used to select products to manufacture in step 2004. In some embodiments, the materials and/or equipment to load onto the MMU may be determined along with products to predictively manufacture by the MMU while or after the MMU travels to the station location. In some embodiments, the steps in FIGS. 19 and 20 may be based on the same set of customer profiles and area customer partialities. In some embodiments, the steps in FIG. 20 may be performed with information updated after the MMU is loaded with manufacturing materials and/or equipment. In some embodiments, the system may select manufacturing materials and/or equipment to load onto an MMU based on the method described with reference to FIG. 19 and may select products to predictively manufacture with the manufacturing materials and/or equipment based on the method shown described with reference to FIG. 20. In some embodiments, the steps of FIG. 20 may be repeated a number of times while the MMU is dispatched. In some embodiments, a system may perform one or more steps of FIG. 19 without performing one or more steps of FIG. 20 and vice versa.

Referring next to FIG. 21, a block diagram of a system according to some embodiments is shown. The system comprises a central computer system 2110, a customer profile database 2114, a product database 2115, and a mobile manufacturing unit (MMU) 2120.

The central computer system 2110 may comprise a processor-based system such as one or more of a server system, a computer system, a cloud-based server, a dispatch center computer system, an MMU management system, and the like. The control circuit 2111 may comprise a processor, a central processor unit, a microprocessor, and the like. The memory 2112 may include one or more of a volatile and/or non-volatile computer readable memory devices. In some embodiments, the memory 2112 stores computer executable codes that cause the control circuit 2111 to select manufacturing materials and/or equipment to load onto the MMU 2120 based on the information in the customer profile database 2114 and the product database 2115. In some embodiments, the memory 2112 stores computer executable codes that cause the control circuit 2111 to provide predictive manufacturing instruction to the MMU based on the information in the customer profile database 2114 and the product database 2115. In some embodiments, the control circuit 2111 may further be configured to update the customer partiality vectors and customer locations in the customer profile database 2114. In some embodiments, computer executable code may cause the control circuit 2111 to perform one or more steps described with reference to FIGS. 19 and/or 20 herein.

The central computer system 2110 may be coupled to the customer profile database 2114 and/or the product database 2115 via a wired and/or wireless communication channels. The customer profile database 2114 may be configured store customer profiles for a plurality of customers. Each customer profile may comprise one or more of customer name, customer location(s), customer demographic information, and customer partiality vectors. Customer partiality vectors may comprise one or more of a customer value vectors, customer preference vectors, customer affinity vectors, and customer aspiration vectors. In some embodiments, the customer partiality vectors may be determined and/or updated based one or more of customer purchase history, customer survey input, customer reviews, customer item return history, customer return comments, etc. In some embodiments, customer partialities determined from a customer's purchase history in one or more product categories and may be used to match the customer to a product in a category from which the customer has not previously made a purchase. For example, customer partialities determined from the customer's purchase of snacks and pet foods may indicate that the user values natural products. The partiality vector and magnitude associated with natural products may then be used to match the user to products in the beauty and personal care categories.

The product database 2115 may store one or more profiles of products that can potentially be manufactured on one or more MMUs and/or materials that may be used for mobile manufacturing. In some embodiments, the product profiles may associate vectorized product characterizations with manufacturing materials and/or finished products. In some embodiments, the vectorized product characterizations may comprise one or more of vectors associated with customer values, preferences, affinities, and/or aspirations in reference to the products. For example, a product profile may comprise vectorized product value characterization that includes a magnitude that corresponds to how well the product aligns with a customer's cruelty-free value vector. In some embodiments, the vectorized product characterizations may be determined based on one or more of product or material packaging description, product or material ingredients list, product or material specification, brand reputation, and customer feedback.

While the customer profile database 2114 and the product database 2115 are shown to be outside the central computer system 2110 in FIG. 21, in some embodiments, the customer profile database 2114 and/or the product database 2115 may be implemented as part of the central computer system 2110 and/or the memory 2112. In some embodiments, the customer profile database 2114 and the product database 2115 comprise database structures that represent customer partialities and product characterizations, respectively, in vector form.

The MMU 2120 comprises a control circuit 2121 and manufacturing equipment 2125. The MMU 2120 may comprise any type of vehicles configured to carry the manufacturing equipment 2125 and manufacturing materials. In some embodiments, an MMU 2120 may be configured to travel to a location to provide on-site manufacturing of items for customer purchase. For example, when a customer orders a customized items, an MMU 2120 located near the customer may begin to manufacture the item with the manufacturing equipment 2125 on the MMU 2120 and have the item ready for customer pickup when the customer arrives at the MMU 2120. In some embodiments, the MMUs 2120 may be dispatched to different neighborhoods to perform mobile manufacturing for customers in each area. In some embodiments, an MMU 2120 may comprise a motored vehicle such as one or more of a truck, a van, a truck and trailer, and the like. Generally, the MMU 2120 may comprise any vehicle with sufficient capacity to carry selected manufacturing materials and manufacturing equipment 2125. In some embodiments, the MMU 2120 may comprise a manned or unmanned vehicle such as an unmanned ground vehicle (UGV). The control circuit 2121 of the MMU may be configured to receive instructions from and/or provide updates to the central computer system 2110. In some embodiments, the control circuit 2121 may be further configured to provide instructions to the manufacturing equipment 2125 onboard the MMU 2120. In some embodiments, the control circuit 2121 may be configured to perform at least some of the steps described with reference to FIGS. 19 and 20 herein. In some embodiments, the MMU 2120 may comprise a communication device configured to communication with the central computer system 2110. In some embodiments, the communication device may comprise a wireless communication transceiver such as a mobile data network transceiver, a cellular transceiver, a Wi-Fi transceiver, a satellite transceiver, and the like. In some embodiments, the MMU 2120 may comprise other components typical of a vehicle such as vehicle controls, wheels, an engine, a power source (e.g. fuel tank, battery, etc.), navigation system, user interface devices, temperature control system, etc. In some embodiments, the MMU 2120 may comprise a power connection for coupling with the power grid at a dispatch location to supply power to the control circuit 2121, the manufacturing equipment 2125, and/or other vehicle components.

In some embodiments, manufacturing equipment 2125 may comprise equipment configured to turn manufacturing materials into products for sale. In some embodiments, manufacturing equipment 2125 may comprise one or more of a 3D printer, a sewing machine, a printer, a laser cutter, a screen printer, a decal applicator, etc. In some embodiments, the manufacturing equipment may comprise automated machinery that may receive instructions from a control circuit 2121 onboard an MMU 2120 and/or the central computer system 2110. For example, the central computer system 2110 may send a 3D model to a 3D printer on the MMU 2120 and the 3D printer may be configured to automatically produce the 3D item based on the 3D model. In some embodiments, the manufacturing equipment 2125 may comprise semi-automatic machinery configured to finish products for sale. For example, an associated may load a t-shirt into a screen printer, and the screen printer may be configured to print an image received from a computer system to finish the t-shirt. In some embodiments, the manufacturing equipment 2125 may comprise manually operated equipment. For example, an associate may be instructed to assemble a delivery receiving box with tools on the MMU 2120 for a customer purchase.

In some embodiments, one or more pieces of manufacturing equipment 2125 may comprise their own control circuit configured to carry out manufacturing tasks. In some embodiments, the manufacturing equipment 2125 may comprise one or more of a permanently or semi-permanently installed equipment pieces on the MMU. In some embodiments, the manufacturing equipment 2125 may comprise one or more modular components that may be selected added to and removed from the equipment set on the MMU 2120. In some embodiments, the manufacturing equipment 2125 may comprise standalone portable equipment that may be selectively loaded and unloaded from the MMU 2120. In some embodiments, the manufacturing equipment 2125 may be configured to be coupled to the MMU 2120 via one or more of a data connection and a power connection. In some embodiments, the power system of the MMU 2120 may be configured to supply power to operate the manufacturing equipment 2125. In some embodiments, the control circuit 2121 may be communicatively coupled to the controls of the manufacturing equipment 2125 to provide instructions and/or receive status information from the manufacturing equipment. In some embodiments, the manufacturing equipment 2125 may communication with the central computer system 2110 via the control circuit 2121 of the MMU 2120 and/or independently via a communication device of the manufacturing equipment. In some embodiments, the manufacturing equipment 2125 may be configured to operate while onboard the MMU 2120. In some embodiments, the manufacturing equipment 2125 may be configured to operate while the MMU 2120 is stationary and/or traveling with the manufacturing equipment 2125 onboard.

While one MMU 2120 is shown in FIG. 21, the central computer system 2110 may be configured to management a plurality of MMUs serving one or more geographic areas. In some embodiments, the central computer system 2110 may be configured to coordinate the movement and/or materials carried on a plurality of MMUs. For example, when an MMU is running low on manufacturing materials, the central computer system 2110 may send another MMU to replace the deployed MMU and/or send a transport vehicle to replenish the MMU. In another example, a plurality of MMUs may be sent to the same geographic area to offer different types of mobile manufactured products.

In some embodiments, the system may perform sales forecast for mobile manufacturing. The system may aggregate data for a geographic area location such as aggregating area customer value vectors. In some embodiments, MMUs may comprise customizable trailer or fleet of trailers. In some embodiments, a MMUs may be configured to provide 3D printing, screen printing, etc. to customers. In some embodiments, items ordered by customers and manufactured by a mobile manufacturing unit may be sent to a local store location for pickup, pickup by a customer at an MMU, or delivered to a customer specified location.

In one embodiment, a system for providing mobile manufacturing, comprises a customer profile database storing customer partiality vectors associated with a plurality of customers, a product database storing vectorized product characterizations associated with a plurality of products, a mobile manufacturing unit comprising a vehicle carrying manufacturing equipment; and a control circuit coupled to the customer profile database, the product database, and the mobile manufacturing unit. The control circuit being configured to select a plurality of customer profiles associated with a geographic area from the customer profile database, aggregate a plurality of customer partiality vectors associated with the plurality of customers to determine aggregated area customer partiality vectors, determine alignments between the aggregated area customer partiality vectors and vectorized product characterizations associated with the plurality of products stored in the product database, select one or more products to manufacture with the mobile manufacturing unit stationed in the geographic area based on the alignments, and instruct the mobile manufacturing unit to begin manufacturing the one or more products prior to receiving orders for the one or more products.

In one embodiment, A method for providing mobile manufacturing comprises selecting, with a control circuit, a plurality of customer profiles associated with a geographic area from a customer profile database storing customer partiality vectors associated with a plurality of customers, aggregating, with the control circuit, a plurality of customer partiality vectors associated with the plurality of customers to determine aggregated area customer partiality vectors, determining, with the control circuit, alignments between the aggregated area customer partiality vectors and vectorized product characterizations associated with a plurality of products stored in a product database, selecting, with the control circuit, one or more products to manufacture with a mobile manufacturing unit stationed in the geographic area based on the alignments, the mobile manufacturing unit comprises a vehicle carrying manufacturing equipment, and instructing the mobile manufacturing unit to begin manufacturing the one or more products prior to receiving an order for the one or more products.

In one embodiment, an apparatus for providing mobile manufacturing comprises a non-transitory storage medium storing a set of computer readable instructions and a control circuit configured to execute the set of computer readable instructions which causes to the control circuit to: select a plurality of customer profiles associated with a geographic area from a customer profile database storing customer partiality vectors associated with a plurality of customers, aggregate a plurality of customer partiality vectors associated with the plurality of customers to determine aggregated area customer partiality vectors, determine alignments between the aggregated area customer partiality vectors and vectorized product characterizations associated with a plurality of products stored in a product database, select one or more products to manufacture with a mobile manufacturing unit stationed in the geographic area based on the alignments, the mobile manufacturing unit comprises a vehicle carrying manufacturing equipment, and instruct the mobile manufacturing unit to begin manufacturing the one or more products prior to receiving an order for the one or more products.

In one embodiment, a system for providing mobile manufacturing comprises: a customer profile database storing customer profiles for a plurality of customers, product database, a mobile manufacturing unit comprising a vehicle carrying mobile manufacturing equipment, and a control circuit coupled to the customer profile database, the product database, and the mobile manufacturing unit. The control circuit being configured to: determine area customer partialities for a geographic area based on the customer profile database, determine an estimated demand based on the area customer partialities and the product database, select a plurality of manufacturing materials for the geographic area based on the estimated demand, and cause the plurality of manufacturing materials to be loaded onto the mobile manufacturing unit.

In some embodiments, the customer profiles comprise customer partiality vectors associated with the plurality of customers, the customer partiality vectors each represents at least one of a person's values, preferences, affinities, and aspirations. In some embodiments, the control circuit is further configured to determine the area customer partialities for the geographic area based on aggregating a plurality of customer profiles selected based on customer locations associated with each of the plurality of customer profiles. In some embodiments, the estimated demand is further determined based on one or more of: area purchase history, area demographic, current season, current weather, upcoming holidays, and upcoming events. In some embodiments, the control circuit is further configured to cause the mobile manufacturing unit to manufacture one or more products using one or more of the plurality of manufacturing materials based on an order received from a customer. In some embodiments, the control circuit is further configured to receive an order for a product from a customer and select one of a plurality of mobile manufacturing units to manufacture the product based on locations of the plurality of mobile manufacturing units and the customer. In some embodiments, the control circuit is further configured to predict one or more products likely to be ordered by customers in the geographic area based on the area customer partialities and the product database and cause the mobile manufacturing unit to begin manufacturing the one or more products prior to receiving a order for the one or more products. In some embodiments, the control circuit is further configured to select one or more manufacturing equipment pieces for the geographic area based on the estimated demand and cause the one or more manufacturing equipment pieces to be loaded onto the mobile manufacturing unit. In some embodiments, the control circuit is further configured to determine quantities of each of the one or more manufacturing materials to be loaded onto the mobile manufacturing unit based on the area customer partialities. In some embodiments, the control circuit is further configured to select one or more additional manufacturing materials to replenish to the mobile manufacturing unit while the mobile manufacturing unit is deployed based on one or more of: products manufactured by the mobile manufacturing unit, products ordered by customers in the geographic area, and a quantity of one or more of the plurality of manufacturing materials on the mobile manufacturing unit and cause a delivery vehicle to transport the one or more additional manufacturing materials to the mobile manufacturing unit.

In one embodiment, a method for providing mobile manufacturing comprises determining, with a control circuit, an area customer partialities for a geographic area based on customer profiles for a plurality of customers stored in a customer profile database, determining, with the control circuit, an estimated demand based on the area customer partialities and product characteristics of a plurality of products stored in a product database, selecting, with the control circuit, a plurality of manufacturing materials for the geographic area based on the estimated demand, and causing the plurality of manufacturing materials to be loaded onto a mobile manufacturing unit comprising a vehicle carrying mobile manufacturing equipment.

In some embodiments, the customer profiles comprise customer partiality vectors associated with the plurality of customers, the customer partiality vectors each represents at least one of a person's values, preferences, affinities, and aspirations. In some embodiments, the method further comprises determining the area customer partialities for the geographic area based on aggregating a plurality of customer profiles selected based on customer locations associated with each of the plurality of customer profiles. In some embodiments, the estimated demand is further determined based on one or more of: area purchase history, area demographic, current season, current weather, upcoming holidays, and upcoming events. In some embodiments, the method further comprises causing the mobile manufacturing unit to manufacture one or more products using one or more of the plurality of manufacturing materials based on an order received from a customer. In some embodiments, the method further comprises receiving an order for a product from a customer and selecting one of a plurality of mobile manufacturing units to manufacture the product based on locations of the plurality of mobile manufacturing units and the customer. In some embodiments, the method further comprises predicting one or more products likely to be ordered by customers in the geographic area based on the area customer partialities and the product database and causing the mobile manufacturing unit to begin manufacturing the one or more products prior to receiving a order for the one or more products. In some embodiments, the method further comprises selecting one or more manufacturing equipment pieces for the geographic area based on the estimated demand and causing the one or more manufacturing equipment pieces to be loaded onto the mobile manufacturing unit. In some embodiments, the control circuit is further configured to determine quantities of each of the one or more manufacturing materials to be loaded onto the mobile manufacturing unit based on the area customer partialities.

In one embodiment, an apparatus for providing mobile manufacturing comprises: a non-transitory storage medium storing a set of computer readable instructions and a control circuit configured to execute the set of computer readable instructions which causes to the control circuit to: determine an area customer partialities for a geographic area based on customer profiles for a plurality of customers stored in a customer profile database, determine an estimated demand based on the area customer partialities and product characteristics of a plurality of products stored in a product database, select a plurality of manufacturing materials for the geographic area based on the estimated demand, and cause the plurality of manufacturing materials to be loaded onto a mobile manufacturing unit comprising a vehicle carrying mobile manufacturing equipment.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

This application is related to, and incorporates herein by reference in its entirety, each of the following U.S. applications listed as follows by application number and filing date: 62/323,026 filed Apr. 15, 2016; 62/341,993 filed May 26, 2016; 62/348,444 filed Jun. 10, 2016; 62/350,312 filed Jun. 15, 2016; 62/350,315 filed Jun. 15, 2016; 62/351,467 filed Jun. 17, 2016; 62/351,463 filed Jun. 17, 2016; 62/352,858 filed Jun. 21, 2016; 62/356,387 filed Jun. 29, 2016; 62/356,374 filed Jun. 29, 2016; 62/356,439 filed Jun. 29, 2016; 62/356,375 filed Jun. 29, 2016; 62/358,287 filed Jul. 5, 2016; 62/360,356 filed Jul. 9, 2016; 62/360,629 filed Jul. 11, 2016; 62/365,047 filed Jul. 21, 2016; 62/367,299 filed Jul. 27, 2016; 62/370,853 filed Aug. 4, 2016; 62/370,848 filed Aug. 4, 2016; 62/377,298 filed Aug. 19, 2016; 62/377,113 filed Aug. 19, 2016; 62/380,036 filed Aug. 26, 2016; 62/381,793 filed Aug. 31, 2016; 62/395,053 filed Sep. 15, 2016; 62/397,455 filed Sep. 21, 2016; 62/400,302 filed Sep. 27, 2016; 62/402,068 filed Sep. 30, 2016; 62/402,164 filed Sep. 30, 2016; 62/402,195 filed Sep. 30, 2016; 62/402,651 filed Sep. 30, 2016; 62/402,692 filed Sep. 30, 2016; 62/402,711 filed Sep. 30, 2016; 62/406,487 filed Oct. 11, 2016; 62/408,736 filed Oct. 15, 2016; 62/409,008 filed Oct. 17, 2016; 62/410,155 filed Oct. 19, 2016; 62/413,312 filed Oct. 26, 2016; 62/413,304 filed Oct. 26, 2016; 62/413,487 filed Oct. 27, 2016; 62/422,837 filed Nov. 16, 2016; 62/423,906 filed Nov. 18, 2016; 62/424,661 filed Nov. 21, 2016; 62/427,478 filed Nov. 29, 2016; 62/436,842 filed Dec. 20, 2016; 62/436,885 filed Dec. 20, 2016; 62/436,791 filed Dec. 20, 2016; 62/439,526 filed Dec. 28, 2016; 62/442,631 filed Jan. 5, 2017; 62/445,552 filed Jan. 12, 2017; 62/463,103 filed Feb. 24, 2017; 62/465,932 filed Mar. 2, 2017; 62/467,546 filed Mar. 6, 2017; 62/467,968 filed Mar. 7, 2017; 62/467,999 filed Mar. 7, 2017; 62/471,804 filed Mar. 15, 2017; 62/471,830 filed Mar. 15, 2017; 62/479,525 filed Mar. 31, 2017; 62/480,733 filed Apr. 3, 2017; 62/482,863 filed Apr. 7, 2017; 62/482,855 filed Apr. 7, 2017; 62/485,045 filed Apr. 13, 2017; Ser. No. 15/487,760 filed Apr. 14, 2017; Ser. No. 15/487,538 filed Apr. 14, 2017; Ser. No. 15/487,775 filed Apr. 14, 2017; Ser. No. 15/488,107 filed Apr. 14, 2017; Ser. No. 15/488,015 filed Apr. 14, 2017; Ser. No. 15/487,728 filed Apr. 14, 2017; Ser. No. 15/487,882 filed Apr. 14, 2017; Ser. No. 15/487,826 filed Apr. 14, 2017; Ser. No. 15/487,792 filed Apr. 14, 2017; Ser. No. 15/488,004 filed Apr. 14, 2017; Ser. No. 15/487,894 filed Apr. 14, 2017; 62/486,801, filed Apr. 18, 2017; 62/510,322, filed May 24, 2017; 62/510,317, filed May 24, 2017; Ser. No. 15/606,602, filed May 26, 2017; 62/513,490, filed Jun. 1, 2017; Ser. No. 15/624,030 filed Jun. 15, 2017; Ser. No. 15/625,599 filed Jun. 16, 2017; Ser. No. 15/628,282 filed Jun. 20, 2017; 62/523,148 filed Jun. 21, 2017; 62/525,304 filed Jun. 27, 2017; Ser. No. 15/634,862 filed Jun. 27, 2017; 62/527,445 filed Jun. 30, 2017; Ser. No. 15/655,339 filed Jul. 20, 2017; Ser. No. 15/669,546 filed Aug. 4, 2017; and 62/542,664 filed Aug. 8, 2017; 62/542,896 filed Aug. 9, 2017; Ser. No. 15/678,608 filed Aug. 16, 2017; 62/548,503 filed Aug. 22, 2017; 62/549,484 filed Aug. 24, 2017; Ser. No. 15/685,981 filed Aug. 24, 2017; 62/558,420 filed Sep. 14, 2017; Ser. No. 15/704,878 filed Sep. 14, 2017; and 62/559,128 filed Sep. 15, 2017.

What is claimed is:

1. A system for providing mobile manufacturing, comprising:
a customer profile database storing customer partiality vectors associated with a plurality of customers;
a product database storing vectorized product characterizations associated with a plurality of products;
a mobile manufacturing unit comprising a vehicle carrying manufacturing equipment; and
a control circuit coupled to the customer profile database, the product database, and the mobile manufacturing, the control circuit being configured to:
select a plurality of customer profiles associated with a geographic area from the customer profile database;
aggregate a plurality of customer partiality vectors associated with the plurality of customers to determine aggregated area customer partiality vectors;
determine alignments between the aggregated area customer partiality vectors and vectorized product characterizations associated with the plurality of products stored in the product database;
select one or more products to manufacture with the mobile manufacturing unit stationed in the geographic area based on the alignments; and
instruct the mobile manufacturing unit to begin manufacturing the one or more products prior to receiving orders for the one or more products.

2. The system of claim 1, wherein the customer partiality vectors each represents at least one of a person's values, preferences, affinities, and aspirations.

3. The system of claim 1, wherein the customer partiality vectors comprise value vectors each comprising a magnitude that corresponds to the customer's belief in good that comes from an order associated with that value.

4. The system of claim 1, wherein the plurality of customer profiles are selected based on customer locations associated with each of the plurality of customer profiles.

5. The system of claim 1, wherein the control circuit is further configured to update the aggregated area customer partiality vectors and the selection of one or more products to manufacture based on customer locations changes associated with one or more customer profiles stored in the customer profile database.

6. The system of claim 1, wherein the control circuit is further configured to associate a set of default partiality vectors with a new customer of the customer profile database, the set of default partiality vectors being selected based on the new customer's demographics information.

7. The system of claim 1, wherein the plurality of customer partiality vectors are aggregated by combining magnitudes associated with each partiality vector.

8. The system of claim 1, wherein the plurality of customer partiality vectors are aggregated by clustering similar partiality vectors associated with the plurality of customers.

9. The system of claim 1, wherein the control circuit is further configured to determine quantities of the one or more products to manufacture based on the aggregated area customer partiality vectors.

10. The system of claim 1, wherein the one or more products are selected further based on one or more of: area purchase history, area demographic, current season, current weather, upcoming holidays, and upcoming events.

11. A method for providing mobile manufacturing, comprising:
selecting, with a control circuit, a plurality of customer profiles associated with a geographic area from a customer profile database storing customer partiality vectors associated with a plurality of customers;
aggregating, with the control circuit, a plurality of customer partiality vectors associated with the plurality of customers to determine aggregated area customer partiality vectors;
determining, with the control circuit, alignments between the aggregated area customer partiality vectors and vectorized product characterizations associated with a plurality of products stored in a product database;
selecting, with the control circuit, one or more products to manufacture with a mobile manufacturing unit stationed in the geographic area based on the alignments, the mobile manufacturing unit comprises a vehicle carrying manufacturing equipment; and
instructing the mobile manufacturing unit to begin manufacturing the one or more products prior to receiving an order for the one or more products.

12. The method of claim 11, wherein the customer partiality vectors each represents at least one of a person's values, preferences, affinities, and aspirations.

13. The method of claim 11, wherein the customer partiality vectors comprise value vectors each comprising a magnitude that corresponds to the customer's belief in good that comes from an order associated with that value.

14. The method of claim 11, wherein the plurality of customer profiles are selected based on customer locations associated with each of the plurality of customer profiles.

15. The method of claim 11, further comprising:
updating the aggregated area customer partiality vectors and the selection of one or more products to manufacture based on customer locations changes associated with one or more customer profiles stored in the customer profile database.

16. The method of claim 11, further comprising:
associating a set of default partiality vectors with a new customer of the customer profile database, the set of default partiality vectors being selected based on the new customer's demographics information.

17. The method of claim 11, wherein the plurality of customer partiality vectors are aggregated by combining magnitudes associated with each partiality vector.

18. The method of claim 11, wherein the plurality of customer partiality vectors are aggregated by clustering similar partiality vectors associated with the plurality of customers.

19. The method of claim 11, the one or more products are selected further based on one or more of: area purchase history, area demographic, current season, current weather, upcoming holidays, and upcoming events.

20. An apparatus for providing mobile manufacturing comprising:
a non-transitory storage medium storing a set of computer readable instructions; and
a control circuit configured to execute the set of computer readable instructions which causes to the control circuit to:
select a plurality of customer profiles associated with a geographic area from a customer profile database storing customer partiality vectors associated with a plurality of customers;
aggregate a plurality of customer partiality vectors associated with the plurality of customers to determine aggregated area customer partiality vectors;
determine alignments between the aggregated area customer partiality vectors and vectorized product characterizations associated with a plurality of products stored in a product database;
select one or more products to manufacture with a mobile manufacturing unit stationed in the geographic area based on the alignments, the mobile manufacturing unit comprises a vehicle carrying manufacturing equipment; and
instruct the mobile manufacturing unit to begin manufacturing the one or more products prior to receiving an order for the one or more products.
